(19) United States
(12) Patent Application Publication
(10) Pub. No.: US 2005/0149759 A1
(43) Pub. Date: Jul. 7, 2005

(54) User/product authentication and piracy management system

(75) Inventors: Balamani S. Vishwanath, Austin, TX (US); Brian D. Mantz, Austin, TX (US)

Correspondence Address: LOCKE LIDDELL & SAPP LLP, 600 TRAVIS, 3400 CHASE TOWER, HOUSTON, TX, 77002-3095, US

(73) Assignee: MoveMoney, Inc.

(21) Appl. No.: 11/065,849

(22) Filed: Feb. 25, 2005

Related U.S. Application Data
(63) Continuation of application No. 09/981,251, filed on Oct. 16, 2001.
Application No. 09/981,251 is a continuation-in-part of application No. 09/909,524, filed on Jul. 20, 2001.
Application No. 09/909,524 is a continuation-in-part of application No. 09/847,465, filed on May 2, 2001, now abandoned.
(60) Provisional application No. 60/211,822, filed on Jun. 15, 2000.

(51) Int. Cl. H04L 9/00

(52) U.S. Cl. 713/201

(57) ABSTRACT

A system in the form of a software solution that provides new and unique solutions to the need to secure digital environments. The present invention uses innovative and new forms of multi-factor user authentication and digital identity management, providing levels of security unmatched in the industry. In addition, the system provides new and unique methods of software piracy management including CD media-based copy protection, remote CD media validation, embedded product serialization, protection of electronically distributed software, and remote product installation tracking.

The application is a continuation-in-part of U.S. patent application Ser. No. 09/909,524, filed Jul. 20, 2001 which is a continuation-in-part of U.S. patent application Ser. No. 09/847,465, filed May 2, 2001, which relies upon U.S. Provisional Patent Application Ser. No. 60/211,822 filed Jun. 15, 2000.

### FIELD OF THE INVENTION

The system relates to multiple facets of Sources desiring additional system user authentication and security or product authentication and anti-piracy management tools or applications.

### BACKGROUND OF THE INVENTION

User Identity Management and Authentication

The economic perils currently encountered by online retailers are formidable. The Gartner Group reports, “The costs to e-businesses resulting from fraudulent transactions are expected to increase from an estimated $9 billion in 2001 to over $15 billion in 2003. Companies selling via the Internet or similar wide area network must absorb the costs of disputes with users and of any fraudulent transactions they suffer. That's because online transactions lack a physical receipt that has been signed by the user and can later be verified. Online merchants eat the cost of all chargeback disputes.”

Since 1997, the FTC (Federal Trade Commission) has maintained a Web-based database as a central part of its fraud-tracking program. “In 1997, there were fewer than 1,000 Internet fraud complaints. However, by 2000, that number had increased to over 25,000, roughly 26 percent of all fraud complaints logged.” (www.FTC.com). Identity theft has earned the dubious distinction as the fastest growing crime in America. The relative anonymity and overwhelming reach afforded by the Internet combine to form the driving force behind the drastic increase in identity fraud. In order for online businesses to instill public confidence and to ultimately be successful, they must demonstrate that they can better address the issue surrounding the authentication of their users' true identities. Online travel industry leader Expedia.com illustrated this problem last year when it reported a US $4.1 million charge against revenues for fraudulent transactions.

The use of simple usernames and passwords is not an adequate guarantor (legally or functionally) of user identification as this methodology only provides for one-factor authentication, which is highly insecure. In the U.S., for example, Internet hackers reportedly stole 147,000 AOL passwords during November of 2000 (Austin-American Statesman).

Passwords can be easily compromised through several methods including:
Simple Guessing—users often choose simple, easy to remember passwords that can be inferred.
Theft—several types of software exist that perform network monitoring, keystroke monitoring, and password cracking functions which allow hackers to easily capture active passwords.
Social Manipulation—people can often be manipulated into giving out their passwords, for instance, to someone claiming to be a member of their company's technical support department.

Because the standard use of the credit card over the Internet only requires the credit card number (card not present transactions), a vast majority of Internet transactions are essentially based only on simple one-factor ‘something the user knows’ authentication.

“Credit card fraud is the biggest risk for the e-merchants. While all businesses accepting credit cards face this, the Internet merchant is even more exposed. Brick-and-mortar businesses can verify a signature to prove the authenticity of the payment, but there is no such protection yet for businesses on the Internet. Due to this increased risk, the credit card banks hold Internet merchants 100% liable for the losses and expenses incurred as a result of credit card fraud. The defrauded merchants not only suffer because of the loss of product or services, but they are expected to pay a charge to defray the expenses the bank incurred from dealing with the fraud.”—Gartner Group.

Moreover, businesses have to allot significant budgets towards maintaining network management departments that constantly have to tend to lost passwords, misused passwords, and fraud on the Internet. In fact, the Gartner Group estimates that lost or forgotten passwords alone account for 20-50% of all corporate help desk calls.

From a consumer's perspective, the fear and apprehension surrounding the threat of identity theft results in a lower inclination to take advantage of all that the Internet has to offer. Half of all Internet users refuse to buy online because of their justified fears surrounding identity fraud and the Internet (epaynews.com). This prevailing consumer attitude has significantly curtailed e-business revenue growth in terms of both numbers of transactions as well as transaction dollar amounts. By instilling strong consumer confidence in e-business' ability to protect online identities, a strong user authentication solution converts window shoppers into real customers.

Passwords and simple one-factor authentication models do not positively identify a user, provide an audit trail of user activity, or provide user accountability. A powerful physical authentication mechanism that uniquely, conveniently, and cost effectively provides true user identification and non-repudiation while providing an optional platform for a single universal login/password to allow user access to multiple accounts will set a formidable precedent in the online arena.

Enterprise Application Access and Installation Management

As a significant number of enterprise software applications involve and generate highly sensitive intra-business information, there is an inherent need to restrict internal (to the enterprise) access to these types of applications. Currently, most enterprise software access is secured only by simple usernames and passwords. And as usernames and passwords are simply ‘something the user knows’, these bits of information only provide a highly insecure form of one-factor user authentication within an Intranet environment. The same tools and methods used to compromise passwords in an Internet environment are equally effective in an Intranet environment.

Alternative device-based enterprise user authentication solutions are extremely cost-prohibitive in terms of implementation and maintenance as well as device procurement. The clear need is for an application-driven device-based solution around which developers can construct a sound, affordable user authentication solutions appropriate to specific products and their environments.

A separate, but related issue to that of enterprise software access management is that of enterprise software installation management. Installation agreement enforcement is essentially relegated to the enterprise software purchaser on a ‘good faith’ basis. The larger and more diverse an enterprise is generally correlates with higher rates of installation mismanagement. Although many instances of enterprise installation abuse are, indeed, intentional, a significant number result simply from unintentional oversights. Therefore, an effective method to manage application use with respect to defined license agreements would not only benefit the software manufacturer, but the enterprise customer wishing to comply with those license agreements.

Software Piracy Management

The Software and Information Industry Association (SIIA) disclosed in its 2000 Report on Global Software Piracy that revenues lost by manufacturers of business applications software alone topped $11 Billion in the previous year. This report specifically concentrated on only piracy of business application software and excluded piracy estimations regarding educational and entertainment software products. In a related report, the Business Software Alliance stated that the sum total of lost revenues to software manufacturers (of all types) due to piracy in the U.S. alone was estimated to be $10.07 Billion for the same year.

One particular market segment, the entertainment software industry, clearly illustrates the formidable economic hardships caused by piracy. The IDSA (Interactive Digital Software Association) states in a 2001 press release, “ . . . our industry's piracy problems remain deeply entrenched and pervasive in far too many markets.” The same press release cites from an IIPA (International Intellectual Properties Association) report, “ . . . entertainment software industry losses in the 50 countries studied will once again exceed $3 billion,” and continues, “ . . . this $3 billion figure does not even include losses attributable to Internet piracy, nor losses in other major markets such as the U.S., Canada, Mexico, and much of Western Europe.”

“The cost of worldwide piracy to the industry each year is staggering,” states the IDSA in its 2000-2001 State of the Industry Report. In the same report, the IDSA reports total sales for the entertainment software industry for 2000 were just a shade over $6 billion. Relating the industry piracy data to the industry sales figures indicates that the costs to the industry due to piracy approach that of its overall revenue generation. For nearly every one dollar of legitimately sold entertainment software, another dollar's worth is pirated.

According to the SIIA—“The numerous ways in which software piracy occurs, the ease of duplication and the high quality of pirated software present a significant problem for the software industry. A program that reflects unprecedented technology, years of effort and millions of development dollars can be duplicated or illegally distributed in minutes with the touch of a button. Any PC user can duplicate a product priced from $20 to $20,000 for no more than the cost of a blank CD or at no cost, and that user can make one, a dozen or a thousand functional copies.”

Beyond the obvious negatives, software piracy does perform an invaluable service to most, if not all, companies within the industry. A software application's user base cannot be measured only by units and licenses sold as, in many cases, the number of illegitimate users approach or even outnumber legitimate users. The value of a broad and expanding application user base (whether legitimate or illegitimate purchasers) lies in its ability to generate new, legitimate sales.

A study published in the Journal of Marketing argues that more than 80% of legitimate software sales, within particular market segments, result from or are positively influenced by products that have been pirated.

Pirated software clearly holds significant value to its original manufacturer/publisher:
Piracy expands company, brand, and specific product user bases.
Piracy acts as a strong marketing vehicle, significantly extending the exposure of the company, brand, and product.
Piracy can serve to provide ‘trial’ versions to potential and future legitimate purchasers.

Piracy is a global multi-billion dollar issue for software manufacturers of all types. As pirated products directly and indirectly lead to as much as 80% of legitimate sales in particular market segments, the desire on the part of the industry is to manage the issue to its economic advantage. Altogether or virtually eliminating the issue would only serve to eliminate extended product user bases and, hence, a substantial source of revenue. Within the industry, though, needed piracy management features are highly variable based on market segments, competitive landscapes, and prevailing marketing strategies. The clear need is for an effective, affordable, and flexible solution that maximizes, on a company specific level, the formidable economic opportunities afforded through piracy management.

### SUMMARY OF THE INVENTION

The present invention is a software solution that provides new and unique solutions to the problems previously described. It does this through innovative and new forms of strong user identity as well as software piracy management. These items are listed as follows:

Authentication Service.

The present invention offers a two-factor authentication service combines “something the user knows”, a username and password, with “something the user has”, to form a device preferably referred to as a Smarte Device™. As passwords alone do not truly identify a user, authentication, preferably referred to as Smarte Authentication™, greatly reduces the potential for and costs associated with identity fraud by establishing strong user accountability (true user non-repudiation) and by generating an audit trail of user activity. Smarte Authentication™ is an integrated security component of the pay, preferably referred to as Smarte Pay™, infrastructure which efficiently overcomes the failings of one-factor, password-only authentication systems. The present invention accomplishes strong two-factor digital authentication through the use of highly portable and easy to use Smarte Devices™. Smarte Devices™ include software tokens that reside on handheld PDAs or WAP enabled cell phones, key chain tokens that generate a new authentication code every few seconds, and identification, preferably referred to as Smarte ID™s —unique authentication devices that may be developed and produced in-house. Smarte Devices™ offer strong branding opportunities for partners and clients using Smarte Authentication™. The Smarte ID™ itself is offered in two formats: as a wallet-sized CD or as a Smart Card. Using encrypted digital algorithms capable of being read by any type of CD drive or Smart Card Reader, the Smarte ID™ provides the convenient functionality of alternative two-factor authentication devices, but at a fraction of the cost. In addition to being an integral portion of the Smarte System™ itself, Smarte Authentication™ is structured/designed so that it can act as a stand-alone digital authentication service for third parties independent of the functions of the Smarte Pay™ infrastructure. Also, aside from user authentication, the Smarte ID™ (CD format) also provides product authentication to software manufacturers by preventing the unauthorized use of a product sold on the CD (anti-piracy solution).

### BRIEF DESCRIPTION OF THE DRAWINGS

FIG. 1 is a flowchart of primary system entity relationships;

FIG. 2 depicts basic relationship between Authentication devices, External Sources, and Lots;

FIG. 3 depicts basic system relationships of External Source's their system users and devices;

FIG. 4 depicts basic system relationships regarding system Access Authorizations;

FIG. 5 depicts the basic system relationships regarding Product Authentication;

FIG. 6 depicts the placement of the Screen Identification Code (GUI) for Authentication Screens;

FIG. 7 depicts Authentication Management Screen Layout for Admin Users;

FIG. 8 depicts Authentication Management Screen Layout for External Source Users;

FIG. 9 depicts Screen Layout for Authentication End Users;

FIG. 10 depicts the System Data Structure Layout and record relationships within the system;

FIG. 11 is a table containing the Table Names referenced in FIG. 10;

FIG. 12 is a visual representation of the Smarte CD™ Authentication Device;

FIG. 13 is a visual representation of the Smart Card Authentication Device;

FIG. 14 is a visual representation of the RSA™ SecurID™ Authentication Device;

FIG. 15 is a flow chart of the Smarte Authentication™ plug-in operational and communication flow for Type I Authentication use;

FIG. 16 is a flow chart of the Smarte Authentication™ plug-in operational and communication flow for Type II Authentication use;

FIG. 17 depicts the basic flow of Authentication Responses based on implementation;

FIG. 18 depicts the basic flow of Authentication Responses based on implementation in addition to those depicted in FIG. 17;

FIG. 19 depicts Authentication Plug-in Information Passing Requirements

FIG. 20 is a flow chart of the Smarte Authentication™system operational and communication flow for Product Authentication use;

FIG. 21 is a flow chart depicting the specific Authorization process for Smarte CD™ Devices;

FIG. 22 is a flow chart depicting the specific Authorization process for Smart Card Devices;

FIG. 23 is a flow chart depicting the specific Authorization process for 3^{rd} party Devices;

FIG. 24 is a flowchart depicting the basic flow of the Smarte Authentication device/authorization process;

FIG. 25 depicts a typical Security Arrangement for hardware/software for 3^{rd} party Authentication Processes, using the system as a portal only;

FIG. 26 depicts diagram displaying the Extended DLL data file structure;

FIG. 27 is a flow chart depicting the basic functional flow of the Standard DLL;

FIG. 28 is a flow chart depicting the basic functional flow of the Extended DLL;

FIG. 29 is a flow chart depicting the Validate Device function of the Extended DLL;

FIG. 30 is a flow chart depicting the Extended DLL Validate Device to Serial Number function;

FIG. 31 is a flow chart depicting the Extended DLL Add User ID function;

FIG. 32 is a flow chart depicting the Extended DLL Kill User ID function;

FIG. 33 is a flow chart depicting the Extended DLL Assign Device function;

FIG. 34 is a flow chart depicting the Extended DLL Unassign and Kill Device functions;

FIG. 35 is a flow chart depicting the Extended DLL Validate User function;

FIG. 36 is a flow chart depicting the Extended DLL Validate User ID Exists in System function;

FIG. 37 is a flow chart depicting the Extended DLL Return Device Info for User ID function;

FIG. 38 is a flow chart depicting the Extended DLL Identify User ID and Return Device Info functions;

FIG. 39 is a flow chart depicting the Extended DLL Import Device Info function;

FIG. 40 is a flow chart depicting the Extended DLL Initiate Datafile, Lock Datafile, Unlock Datafile, and Change Locked Datafile Password functions;

FIG. 41 is a flow chart depicting the function of the replication/duplication management software for non-serialized CD-ROMs only containing the media-based copy protection;

FIG. 42 is a flow chart depicting the function of the replication/duplication management software for serialized single set CD-ROMs;

FIG. 43 is a flow chart depicting the function of the replication/duplication management software for serialized sets of CD-ROMs; and

FIG. 44 is an overview diagram depicting plug-in inter-system relationships.

### DETAILED DESCRIPTION OF PREFERRED EMBODIMENT

The following terms are used in this application.

Authorization Protocols

The protocols that check user authorization for specific areas of the System are integrated.

Access Protocols

The protocols that check user access to specific areas of the System are integrated.

Authentication Protocols

The protocols by which the System authenticates a user are integrated.

Record Flags

Records with issues are flagged and maintained indicating current status (closed, pending, completed, etc.).

Product

Refers to Software/distributed Media Products via either Electronic Distribution of the Internet or on CD-Based Media.

Logs and Reports

Activity logs and reporting features have been integrated within the System.

Inventory

Inventory is where information for all devices utilizing the Smarte Authentication System is initially stored prior to issue/use.

User/Entity Profiles

All users and businesses within the System are defined by a basic set of information that comprises their Profile.

Identifiers

In addition to the basic set of information captured in the Profile, additional identifying information are captured by particular entities for particular users within the System. This feature enables a customization of Profile information.

Smarte ID

The System's dual authentication procedure is predicated on the use of devices (hard/soft) to verify the true identity of any user. The System has been developed to recognize these Smarte IDs during the authentication of a user.

Smarte ID Distribution Process

The present invention has defined multiple device distribution methodologies for use with Smarte Authentication as a stand-alone and in conjunction with the System.

Login Management

Across the entire System, every user login code must be unique. Upon the registration of a new user, the System performs a check against all existing logins to ensure the uniqueness of any new logins created.

Session and Security Protocols

Session Security Protocols have been designed and implemented. These include a user definable time-out feature based on user inactivity, a disabling of the browser ‘Back’ button, and an inability of the user to have more than one session open at any one time. Also, the System uses session cookies as opposed to storage cookies.

Authentication Portal

The present invention's Authentication Portal (Smarte Authentication) is integrated into the Smarte System and is presented as a standalone offering as well. The present invention provides strong, two-factor user authentication through the use of such secure devices as CD-ROMS, ID Tokens, ID Business Cards (hard devices), and software installed on PCs, PDAs or wireless cell phones (soft devices).

Entity Crossover

The entity structure allows a USER of the authentication system to also be a SYSTEM user.

Portable Digital Signatures

A portable repository of digital signatures. Users are able to digitally sign documents from anywhere at any time by retrieving the portable repository through unique authentication.

Wireless Transactions/Authentication

Smarte System access for transactions through wireless capable devices.

Contract Signing

With digital signature and strong two-factor user authentication capabilities, contracts are signed and delivered in an online format.

Complete Activity System Log

Complete activity histories for System Users and System Entities are generated within the system.

Product Authentication

Software anti-piracy methodologies are incorporated within the scope of the System to allow software manufacturers to distribute software on CD-ROM media while significantly reducing exposure to piracy and illegal distribution.

Online Voting

With its strong user authentication capability and risk management features, the System supports online voting processes.

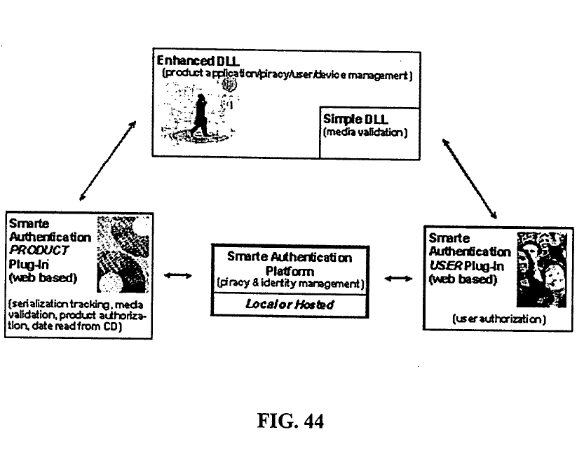

The present invention, currently marketed under the trademark as the MoveMoney™ suite of Smarte™ Authentication and Piracy Management offerings targets online businesses, B2B (Business to Business) and B2C (business-to-consumer) markets. When combined, the structure provides a complete solution for applications requiring both the Internet or similar wide area network and stand-alone resources for piracy management in their application. FIG. 44 is an overview diagram depicting plug-in inter-system relationships that support the system.

System Structure and Entity Relationships

The Structure of the system inherently allows for expansion and additional complexity, even at the “core” of the system, by introducing the methodology of the “unknown”. Using this mentality, wherever there was the possibility of another “type” of anything, should as primary entities, accounts, authentication devices, etc., the structure of the system incorporates the “unknown” type. This methodology for structure requires that should a new “type” of anything be added to the future system, there is no requirement to ever have to go back and “redesign/redefine” the core system. It is simply a matter of adding a single type “code” to an existing data table, and adding additional tables as required, instead of having to essentially redesign the existing system.

At the top level of the hierarchy are the following Primary System (User) Entities:
Administration
External Authentication Sources
End Authentication Users

These entities are linked by an assigned identification initially given to them. Once the identification is linked to an entity, that identification carries over to the others if they are created in the system. In addition, each of the System “users” are also maintained separately within the Smarte Authentication™ portion of the system as independent “End Users” allowing them access to the Smarte Authentication™ system.

In order for Access to any portion of the system to be granted to an individual user, they must be recorded in the system as End Authentication Users. End Users (to whom devices have been issued) maintain no implicit direct access within the system, unless entering as an authorized user into the system via the access granted via the standard Plug-in. Therefore, no special access area exists for them. End Users are maintained at two distinct levels within the Smarte™ Authentication System. The first level is the “common”, or system level, to which each of the End Users are assigned a unique System Identifier, that identifies the Individual, independent of membership or External Source References (including the Smarte System™ itself). No personal information is retained for the End User at this level. The second level is at the level of External Source and External Source End User Reference (i.e.: Login Name) for the particular External Source. This structure allows an individual to be identified, as well as maintain multiple devices across many different external sources where End User's login name/identifier may be different for each of the external sources. Since a Smarte Device™ is assigned to the System Level, rather than at the external source level, it allows devices to be utilized across multiple External Sources.

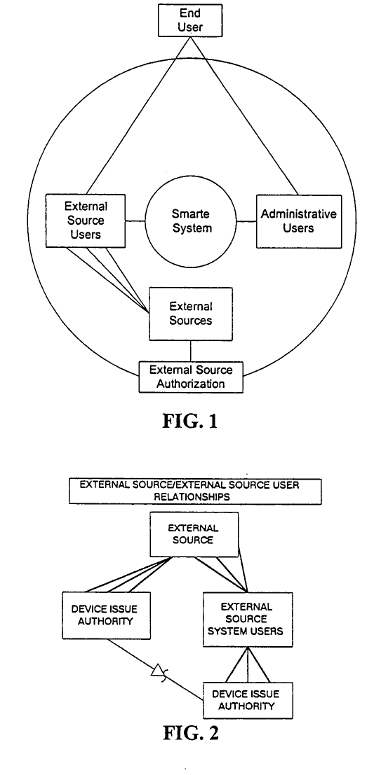

Access to the system is granted to End Users via a Device. Devices are initially maintained maintained by the system in an “inventory”, and are grouped sequentially by “Lots”. Devices are placed into inventory via manual entry, or import of information from a generated import file where the devices have been serialized with a serial number string internally. These devices are issued from inventory to External Sources, for subsequent distribution to End Users. The system, is itself an External Source in this regard as part of the authentication requirements. This relationship is displayed in FIG. 1.

Access Authorizations are the “rules” defined by the external source for particular access to a single site. There are mechanisms within the system that allow for the External Source to dynamically have a single Authorization that can function across multiple access points. In addition, the system is structured to allow a “parent-child” relationship, under which a single authorization can maintain a single processing set of rules, while other specific requirements can be defined under different “child” authorizations, allowing the External Source to call the “parent” authorization, while assigning the individual “children” authorizations to the specific devices as needed. An example of this application would be where access is limited to specific time periods during the day based on a worker's daily shift, and there are three working shifts. Under this scenario, the External Source need set-up and reference only the parent, but can then create and assign an unlimited number of “children”, each one limiting the access time based on shift, to the individual End Users as required. Authorizations “rules” are essentially split into two categories: Functional and End User Access.

Functional Authorization Rules define how the Authorization functions, and directs the plug-in on the External Source Server in how to react to authorization requests. Functional rules include:
SOURCE URL FROM WHICH ACCESS AUTHORIZATION REQUEST ORIGINATES
Single Character Code indicating Base Type of Authorization Application: “U”—User Authentication; “P”—Product Authentication
URL to Pass to Upon Acceptance of Authorization
URL to Pass to Upon Rejection of Authorization
URL to Pass to Upon NOT Found Result (Excludes where Not Found has resulted in Rejection
Static String to Pass to URL Upon Acceptance of Authorization
Static String to Pass to URL Upon Rejection of Authorization
Static String to Pass to URL Upon NOT Found Result (Excludes where Not Found has resulted in Rejection)
Single Character Code indicating TYPE of Implementation regarding the SA System Universal Password.
“N”—None—Universal Password is NOT accepted. This is also the applicable code utilized where a NO password and/or No login access system is utilized. Source Login/Password Combination as acceptance ONLY
“R”—Universal Password REPLACES the Source's Password. The information entered into the Source's password field in the login screen is passed directly to the SA system for primary validation of password.
“S”—Supplemental: The Universal Password is utilized as a secondary password, which can be used as an ALTERNATE to the source's OWN maintained password.
“X”—Indicates that Source system does not REQUIRE or USE a Password at all for THIS authorization. Primary utilization is confirmation points internally within the system, NOT as a primary login/access use.
Single Character Code indicating WHAT type of ACTION is taken upon determination of the acceptance/Rejection Criteria
“P”—Plugin handles subsequent Action based on Acceptance/Rejection Criteria.
“S”—Source handles action based on results passes back by the SA system
APPLICABLE ONLY IF APPLICABLE TRIGGER FIELD is “P”: Single Character Code indicating Type of Passed String Handling to occur
“D”—Dynamic Strings Passed to Plugin
“S”—Static Strings utilized by Plugin—Stored
Perform Anti-Piracy Validation of Device (where applicable)? “Y”—Yes; “N”—No

End User Access Rules define what limits, if any, are placed on the End User's Access. In addition to these being set at the “master” authorization level itself, these rules can also be altered or adjusted for each individual device, providing a means for overriding specific values for individuals. End User Access Rules also apply to the realm of Product Authorization, and are maintained in the same area within the system, as for the purposes of structure, in Product Authentication, the Product Itself is considered to be the End User. End User Access rules include:
Is Access Controlled on Time Basis? (Y/N) (Pertains primarily, but not limited to USER type Authorization)
Contains Beginning Available Access Time for User (Applicable only if Time Lock =(Pertains primarily, but not limited to USER type Authorization)
Contains Ending Available Access Time for User (Applicable only if Time Lock =“Y”) (Pertains primarily, but not limited to USER type Authorization)
Is Access Controlled on Periodic Basis? (Y/N) (Pertains primarily, but not limited to PRODUCT type Authorization)
Total Number of Times per DAY that Access for single DEVICE is granted. NOTE: ACCESS BASED ON DEVICE, NOT USER. (Pertains primarily, but not limited to PRODUCT type Authorization)
Total Number of Times per WEEK that Access for single DEVICE is granted. NOTE: ACCESS BASED ON DEVICE, NOT USER. (Pertains primarily, but not limited to PRODUCT type Authorization)
Total Number of Times per MONTH that Access for single DEVICE is granted. NOTE: ACCESS BASED ON DEVICE, NOT USER. (Pertains primarily, but not limited to PRODUCT type Authorization)
Total Number of Times per YEAR that Access for single DEVICE is granted. NOTE: ACCESS BASED ON DEVICE, NOT USER. (Pertains primarily, but not limited to PRODUCT type Authorization)
Total Number of Times DURING THE LIFE OF THE AUTHORIZATION that Access for single DEVICE is granted. NOTE: ACCESS BASED ON DEVICE, NOT USER. (Pertains primarily, but not limited to PRODUCT type Authorization)
# of DAYS from COMBINATION of: Device Assigned to User (Activated) AND Auth Assigned to Device that: AUTHORIZATION Assigned to Device Expires. AUTO_EXP_DATE. Note: There is No Upper Limit on the Number of DAYS that can be entered, other than the INTEGER Maximum Value itself. Note also that a NULL or ZERO Value in this field indicates NO AUTOMATIC AUTHORIZATION EXPIRATION.
Individual Days of the Week that Access Is granted

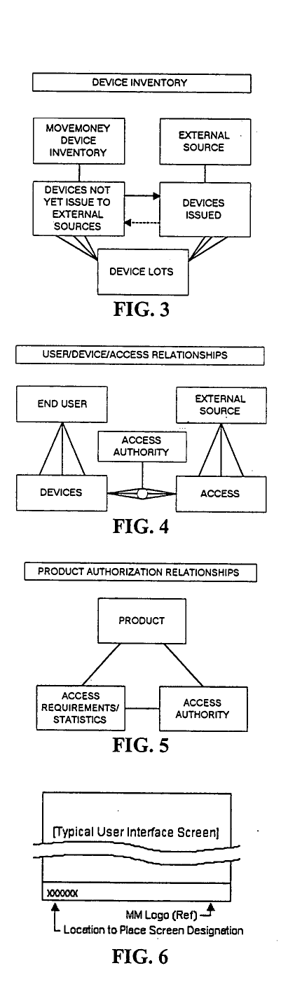

The primary relationship between External Sources, Devices, and System Users (typically External Source employees) is as displayed in FIG. 2. The relationship between inventory and External Sources is as shown in FIG. 3.

The attachment of the Authorization itself, combined with any specific override settings, are used to create an individual Access Authorization entity, unique to each device. This relationship (for End Users) is shown in FIG. 4. The basic relationship of these authorizations in regards to Product Authentication is shown in FIG. 5.

System Screens and User Information Requirements

The present system must itself act as an “external” entity in order to set up and maintain access rights for the Smarte System™ using the functions of the Smarte Authentication™ section. In this manner, there is only a single hardened security and access methodology employed in accessing not only the Smarte System™, but External Source sites as well. This prevents having multiple “weaker” systems filled with exceptions that must be maintained within other areas of primary systems involved, such as the Smarte System™ itself.

Each Individual Screen within the Smarte Authentication™ system is identified by a screen “identification code”, the placement is as shown in FIG. 6. If specific Screens are “duplicated” for different purposes, that the applicable screen designations will remain, however the individual variants of these screens will be followed by an alpha character (A, B, C, etc.) in order to identify the individual variants. Note that this does NOT apply to variations within the SAME form itself, only where these forms are PHYSICALLY separate.

Edit Checks are considered those validations of information that can be performed in regards to themselves, such as is the item a valid “state” or postal code; is a mandatory information entry field left blank, is an entered identification number the correct length and format, etc. These also include validations that can be performed within the same form/data table itself, such as a “date started” could not be entered after a “date ended”.

Guardians refer to validations that must be cross checked against multiple forms or data tables, and include protection against the entry of duplicated records, or records containing information that conflicts with other records or information limitations already in the system. Standard Validations for information within the system is as follows:

Global
Regardless of other checks, all information requirement checks for data are performed at the RECORD level. Additional field level checks may be performed, but are ALWAYS duplicated at the record level. All text fields that require specific data (specific characters) will be coded using the standard text convention to block entry of invalid characters.
Individual Situations and requirements may be applicable to a specific circumstance or particular application where the need to over-ride the standard information edit checks and guardians apply. The following information in this section regarding “standards” is given as a reference only, and is intended to serve as a programming guideline, where such requirements are not implicitly stated elsewhere.
Names
   Full Name; Short Name; Contact Person; First Name; Last Name
      Alphanumeric (a-z, A-Z, 0-9)
      Spaces
      Extended Characters like & (ampersand) . (dot) , (comma) - (hyphen) * (asterisk) ' (Single quote)
   Middle Initial
      Always Optional
      Single Alpha-numeric Character
      Extended Characters NOT permitted
   Name Prefix
      Alphanumeric (a-z, A-Z, 0-9)
      No Spaces
      Extended Character: . (dot)
      Requirement varies with individual application
   Name Suffix
      Alphanumeric (a-z, A-Z, 0-9)
      No Spaces
      Extended Character: . (dot)
      Always an Optional Requirement
Addresses
   2 lines of 30 characters each are always given for “street address” portion. Information cannot exist on the second line if the first line is blank. Rather than error, the program will always shift the second line to the first, then clearing the second line.
   Spaces and Extended Characters are allowed in the Street Address Lines.
   for Cities, Spaces and Extended Characters are allowed.
   Where the 5-digit zip code is optional, if any portion of it is entered, it must be 5-digit numeric, or made blank.
   The 4-digit extension on a Zip Code cannot exist without the 5-digit portion being entered. The four-digit zip code extension is ALWAYS optional.
   “State” must conform to a valid 2 character Postal Code.
   Email
      Alphanumeric (a-z, A-Z, 0-9)
      Special Characters like _ (Underscore) - (hyphen) . (dot) (tilde) ' (Single quote) @ (at the rate)
      Format:
         Before @ Symbol:
         First and Last Character should be Alphanumeric and Special Character can be in-between them
         After @ Symbol:
         First and Last Character should be Alphanumeric and Special
         Character can be in-between them. At least one . (dot) should be in-between First and Last Character
         e.g.:
         move-money@elmaq-software.com
         move money-elmaq@mmc-inc.com
   Web Page
      Alphanumeric (a-z, A-Z, 0-9)
      Special Characters like . (dot) _ (Underscore) - (hyphen)
      Format:
         a.b.c
         a—www
         b—First and Last Character should be Alphanumeric and special Characters can be in-between them
         c—Alphanumeric
         e.g.
         www.movemoney.com
         www.usa.net
Telephone Numbers (includes Fax, Modem, Cell, etc.):
   Phone Numbers are always divided into 3 separate text fields on the screens. Where a phone # is optional, if any portion of the phone number is entered, the entire number must be entered correctly. Area Codes are always required if a phone # is entered.
   Alpha Characters are NOT accepted in the phone number fields.
   Where a telephone# extension field is given, the extension cannot be entered unless a valid phone number exists applicable to that Phone Extension.
Dates:
   All dates entered must be valid (1/1/999 through 12/31/9999).
   All dates that relate to other dates (such as “start” and “end” dates) are validated against each other (example: End date can not be before Start Date).
   Dates are entered and maintained in the system in DD/MM/YYYY format.
   Where Dates are presented on the screen in the form of a selection, the “default” date presented must be “intelligent to the individual application for that/those field(s).
Amounts
   Integer Amount
      Numeric (0-9)
      Size dependant on individual application
   Currency/Fixed (2 Decimal Places)
      Numeric (0-9, and “.”)
      Format:
         Max 16 Characters
         Max 13 Numbers before . (dot)
         2 Numbers after . (dot) (padded with zeroes as/if required
         As Displayed:
         Currency Symbol Precedes Value
   Percentage
      Numeric (0-9, and “.”)
      Format:
         Max 6 Characters
         Max 3 Characters before . (dot)
         Max 2 Characters after . (dot)
         Value should be <=100.00
         As Displayed (without Label Reference to Value “type”):
         “%” Follows Value

External Source Profiles
Mandatory Information:
   Names (both full and abbreviated)
   Date established as “Company/Corporation”
   Plugin Use Type Code
      “S”: User Auth—Single Device/Type
      “M”—User Auth—Multiple Devices/Types
      “P”—Product Authentication
      “C”—Combination
   Sales or Service Category
   Address/Contact Information

External Source Accounts
Must be attached to a Specific External Source
Must be attached to a Bank
Account Number SHOULD pass Account# Format Check
RTN/Account DOES NOT HAVE TO BE unique within the system
Mandatory Information:
   Type of Account (Checking/Savings)
   Actual Name(s) on the Account
Applicable Account Types:
   Checking
   Savings
   Admin

External Source System Users
Mandatory Information:
   Names (First/Last)
   Login Information (Login Name/Password)
   Sales or Service Category
   Address/Contact Information

Devices
Only Devices as defined by the SA system itself may be utilized within the System
A Device May be declared to be “blocked” from Cross Utilization. In this event, the following applies:
   Device Control resides with the Issuing External Source (as well as Admin)
   Devices are “invisible” to other External Sources, as are attached Authorizations.
   Only Devices that have this condition can be “killed” by the issuing external source.
Devices NOT blocked from cross utilization cannot be “Killed” by ANY external source. The action to “Kill” a device results in only the removal of ALL Authorizations previously granted by the External Source attempting to “Kill” the device. ONLY the Administration can “Kill” a cross utilization capable device.

Lots
Lots must be retained in a complete “sequential” series.
Lots cannot cross device types
Lots are to be “split” by the system as needed in order to maintain the sequential series
   In the case of a split required, the low end of the Lot series will retain the original lot designation, and a new lot designation will be applied to that portion of the series following the split.

Device Ownership
For an External Source, Device Ownership is defined as having both Complete Device Control Authority and the ability to transfer that Complete Device Control Authority to another External Source.
Device Ownership originally resides with Inventory.
Issuing a Device to an External Source from Inventory places the Device Ownership with that External Source.
Once an External Source holds Device Ownership, that External Source can Transfer Device Ownership to another External Source.
Device Ownership can be held by one and only one External Source.
An External Source retaining Device Ownership can grant some or all Device Control Authority to another External Source while still holding Device Ownership.

Device Control Authority
Device Control Authority is a set of device management rights including Device Activation, Authorization Attachment, Authorization Removal, and Access Usage Override.
The External Source holding Device Ownership can grant any or all device management rights encompassed by Device Control Authority to other External Sources.
Complete Device Control Authority is conferred when Device. Ownership is transferred from one External Source to another External Source.
Complete Device Control Authority can be held by more than one External Source, provided the External Source holding Device Ownership grants Complete Device Control Authority to another External Source.
If an External Source Transfers Device Ownership, then any Device Control Authority it had granted prior to the Transfer is removed.
Not until Device Ownership is transferred by an External Source can it give up Complete Device Control Authority.
Device Control Authority cannot be extended beyond a Single Level of authority.
Device Control Authority is available only within the platform itself, and is not extended to the “stand-alone” Internet platform, as cross utilization of devices is not an anticipated option.
   System Screens and User Interface

Menus provide the primary navigation for actions to be taken from the screens for the system users, regardless of user type. System users of the system on the Server Access the system controls via the Interface. Users of a Local Server version of the Authentication Server gain access into the system directly. The following is the basic menu structure for the various users within the system:

```
Help (Common)
External Source Login
  Manage [Super User Access Only]
    Authorizations Master
    System User Admin
    View Profile
  Devices
    Transfer
    Assign
    Granted Device Control Authority
    Activate
    Access Authorizations
    Mass Auth Assignment
  End User
    Add
    Edit Profile
  Reports
Admin Login
  External Source
    Add
      Profile
      Account
      External Source System Users
    Manage
      Edit Profile
      Blocking
      System User Activity
      External Source System Users
  Devices
    Inventory
      Add
        Manual Entry
        Import
      Manage
    Issue/Transfer
    Granted Device Control Authority
  Activate
  Assign
  Access Authorizations
  Mass Auth Assignment
End Users
  Add End User
  Import End User
  Edit End User
Reports
Security Officer (Available to Select Users Only)
  Manage System (Administration) Users
  General Parameters
  Remove External Source
```

System Screens and Layout

Screen Style (“Look and “Feel”) is maintained consistent throughout the system. All Screens maintains the Current System User's Login Name in the upper left hand corner. The primary entry screen is as follows:
Log-In: In this screen, the user enters Log-in name and password.
   Device Handling: This screen appears, specific to the type of physical verification device that the user has been assigned. If the user has instead locked the ID to the particular machine, the alternate screen is utilized instead only if the user is downloading the “key” for the first time.
      (or)
   1^{st} Time Download: This screen allows a NEW user to download an encrypted algorithmic key to their individual computer on a one time basis, thereby locking their access as a member to the system to a single machine.

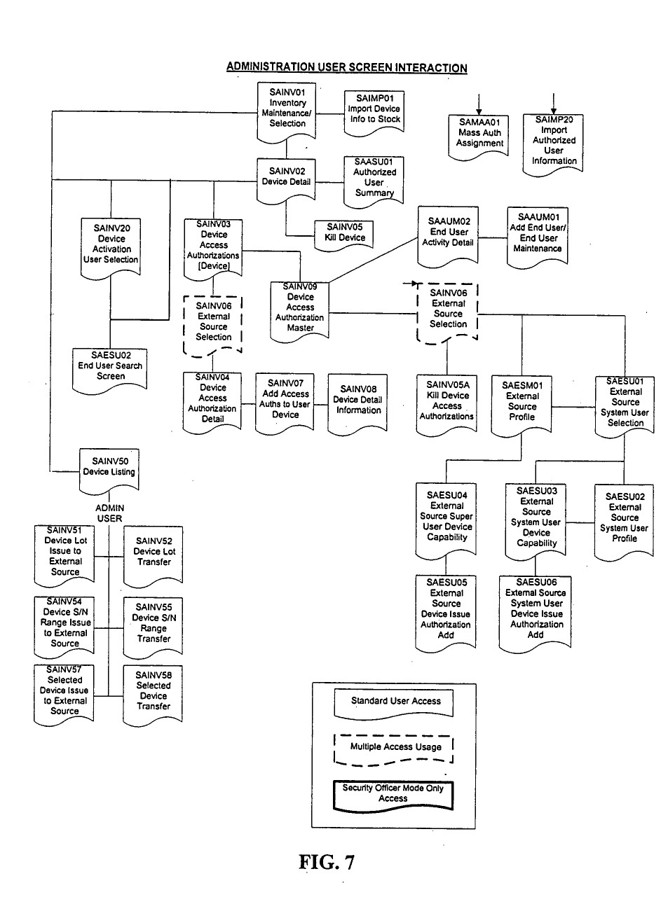

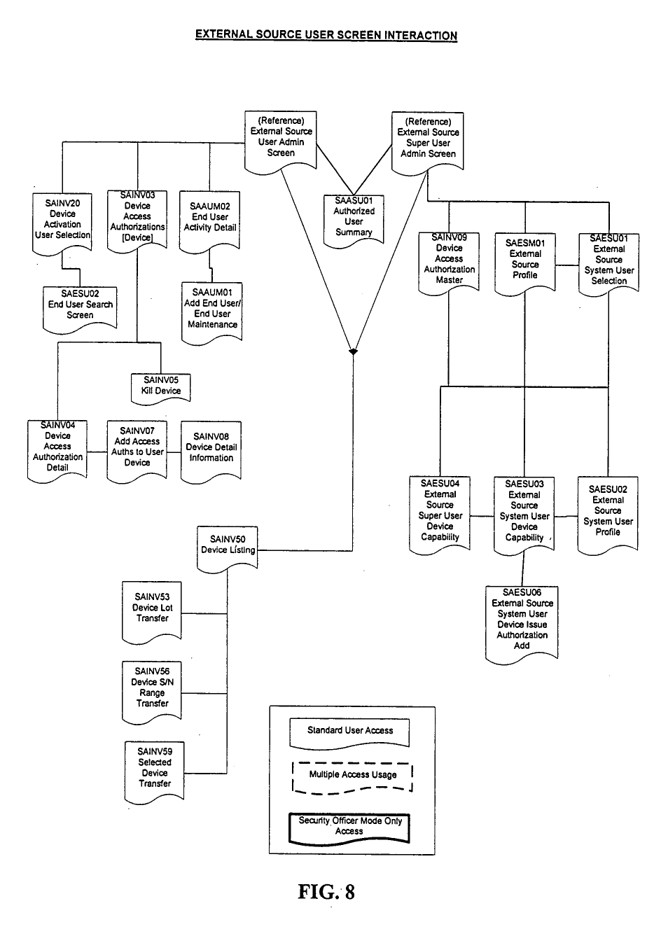

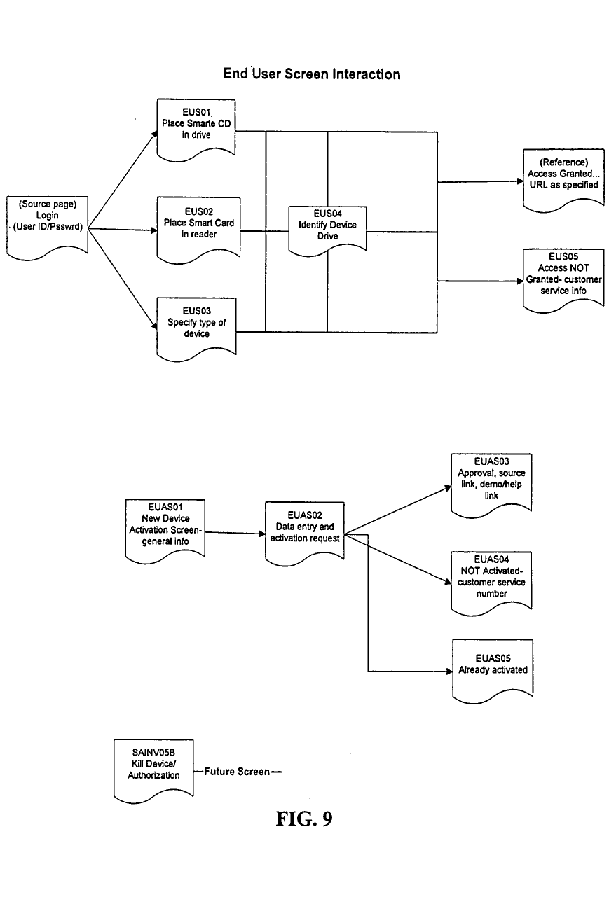

The System Screens, with relationships to each other, are displayed in FIG. 7, FIG. 8, and FIG. 9.

Security Officer Mode: This screen requests access to Security Officer Mode, displays Officer Activity Log, etc. Also permits a Security Officer to Return to Standard Admin User mode if in Security Officer Mode.

User Admin (User Selection): This screen is the primary screen for selecting Administrative user profiles/security settings for Add/Edit/Delete.
Add User: Contains information entry and requirements for adding Administrative personnel.
   (OR)
Edit User: Contains information entry and requirements for adding Administrative personnel.
   Permissions: Contains Permissions for applicable Administrative Personnel.
   Security: Contains System Security Settings for applicable Administrative Personnel.
Site Parameters: Primary Entry/Option Screen for Site Parameter Maintenance within the Smarte System™
   Categories: Add/Edit/“delete” of Categories allowed for use within the system.
   Account Codes: Add/Edit/“delete” of Account Codes allowed for use within the system.
Manage Devices: Redirects to Authentication™ Portion

The listing of the Screens for the Interface to the Authentication portion of the system, as displayed in FIG. 7, FIG. 8, and FIG. 9. The listing of these screens is as follows:

| | |
|---|---|
| EUS01 | Place Smarte CD ™ in Drive |
| EUS02 | Place Smart Card in Reader |
| EUS03 | Specify Type of Device |
| EUS05 | Access NOT Granted - customer service info |
| EUAS02 | Data Entry and Activation Request |
| EUAS03 | Approval, Source Link, Demo/Help Link |
| EUAS04 | NOT Activated - Customer Service Info |
| EUAS05 | Already Activated |
| EUPW01 | UNIVERSAL PASSWORD HOME |
| EUPW02 | UNIVERSAL PASSWORD ENTRY |
| EUPW03 | UNIVERSAL PASSWORD CHANGE |
| EUSO10 | Kill Device/Authorization |
| SAAUM01 | Add End User/End User Maintenance |
| SAASU01 | End User Selection |
| SAAUT05 | AUTHORIZATIONS TO BE GRANTED |
| SAESD01 | Granted Device Control Authority Selection |
| SAESD02 | Granted Device Control Authority Detail |
| SAESM01 | External Source Profile |
| SAESU01 | External Source System User Selection |
| SAESU02 | External Source System User Profile |
| SAESU03 | External Source System User Device ISSUE Capability |
| SAESU04 | External Source Super User Device Capability |
| SAESU05 | External Source Super User Device Issue |
| | Authorization - New |
| SAESU06 | External Source System User Device Issue |
| | Authorization - New |
| SAIMP20 | Import Device Info to Stock” and “Import |
| | Authorized User Information |
| SAINV01 | Inventory Maintenance - Selection |
| SAINV02 | Device Detail (DISPLAY SCREEN ONLY) |
| SAINV02A | Device Detail |
| SAINV03 | Device Access Authorizations |
| SAINV04 | Device Access Authorization Detail |
| SAINV05 | Kill Device |
| SAINV05A | Kill Device Access Authorizations |
| SAINV06 | External Source Selection |
| SAINV09 | Device Access Authorization Master |
| SAINV09W | Authorization Master WARNING |
| SAINV32 | Master Device List |
| SAINV40 | Authorization Master List |
| SAINV41 | Interface Information Request |
| SAINV42 | External Source System User Home Page |
| SAINV43 | Removing External Source |
| SAINV44 | End User Authorization Master |
| SAINV45 | External Source Device Listing |
| SAINV47 | END USER Devices |
| SAINV47A | END USER Devices |
| SAINV48 | Device Detail Entry |
| SADEVxxx | DEVICE READ SCREENS (MULTIPLES) |
| SAINV49 | Activation Entry |
| SAINV50 | Device Selection/Issue to External Source |
| SAINV51 | Device Lot Issue to External Source |
| SAINV52 | Device Lot Transfer |
| SAINV53 | Device Lot Transfer |
| SAINV54 | Device S/N Range Issue to External Source |
| SAINV55 | Device S/N Range Transfer |
| SAINV56 | Device S/N Range Transfer |
| SAINV57 | Selected Device Issue to External Source |
| SAINV58 | Selected Device Transfer |
| SAINV59 | Selected Device Transfer |
| SAMAA01 | Mass Auth Assignment |

System Data Structure

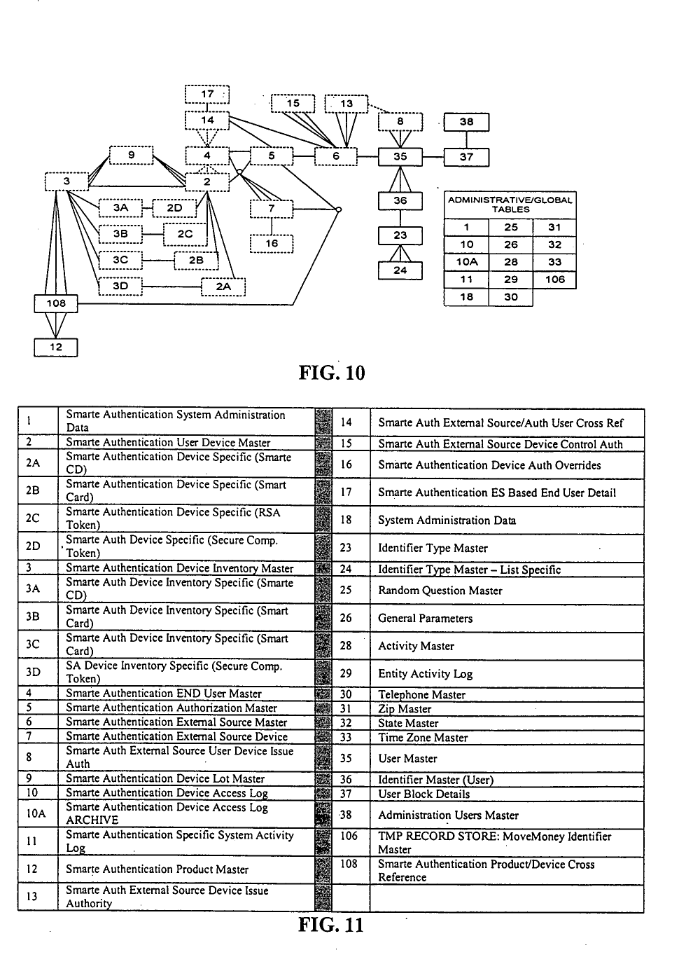

The methodology used in defining the structure of the system is one where any “thing” that either has, or could have multiple “types”, is structured so that there is a “master” table, containing information that would be common to ALL types, as well as an identifier code within this record indicating the specific “type”. Related to this “master” data table, are individual tables then that contain information specific to the individual “types”. When a new “type” is added, while additional code will have to be created within the system itself to handle this new “type”, the “master” table does not have to be altered, and the addition of a specific type table is all that is then required. Based on this principle, there is no need to have to “redesign/restructure” the system in order to add a new entity type. This methodology has significant advantages in that additions to the system can be “plugged in” rather than having to redesign/recode entire sections of the system or adding additional fields to data tables that would only be used for that specific type. The Smarte System™ Data Table Structure and inter-table relationships (one to many, many to one, one to one) is depicted in FIG. 10. The descriptions of the items in FIG. 10 are detailed in the Table in FIG. 1 1.

Devices

Access to the system is granted to End Users via a Device. Devices are initially maintained by the system in an “inventory”, and are grouped sequentially by “Lots”. This relationship is displayed in FIG. 3. Physical Devices are supplemental to the individual user's Standard Login and Password. Once the Login (and Password/Supplemental Information) is/are received by the Security Server, the information is then matched to the System's Database. The Type of device that the user has been issued is then retrieved by the system. Dependant upon the type of issued device, the system then requests additional information from the user, by either direct data entry or physical device insertion into the appropriate reader. From this, the information obtained is then validated via the security system, whether it can be processed internally, or passed to an outside agent, (such as the RSA ACE Server) with the Security System acting as the intermediary between the systems. This methodology allows the Smarte Authentication™ System to maintain a map between multiple systems and device types, as well as provide the future capability to allow cross platform access between participating entities.

The Smarte Authentication™ portion of the system is designed to allow virtually any device “type” to be utilized for authentication purposes. The device types currently employed/structured for in the system are: Smarte CD™; Smart Card; Soft ID; and 3^{rd} Party Tokens.

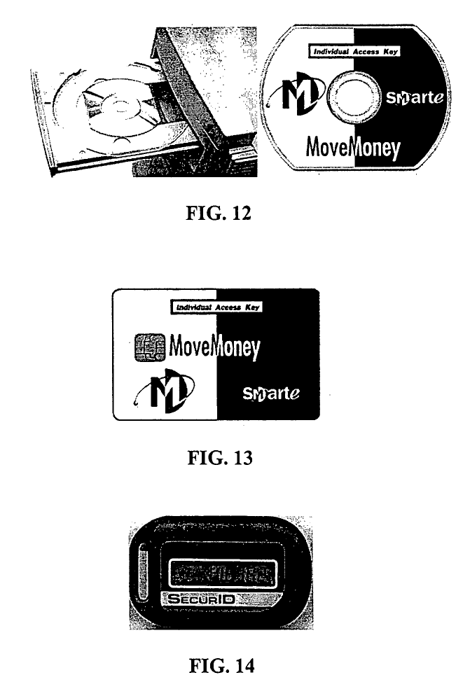

The Smarte CD™ is a serialized device application of a standard business card sized CD ROM disk, playable in virtually any existing data type capable CD Drive. A picture of the Smarte CD™ is shown in FIG. 12.The Smarte CD™ has the following “optional” features, of which one or both types of “serialization” must be incorporated in order for the CD itself to be a viable means of authentication of the individual user:
Serialized “Content” File (Style I): This file is a 220 character “intelligent” encrypted file that allows the individual CD to be tracked not only be Serial Number, but date of generation and individual generation site. Encryption follows the proprietary Random Based encryption methods, and is decipherable only by the CD Generator unit. Because the Decryption code does NOT reside anywhere on the Server, but within Stand-alone units NOT tied directly to access from the Internet, it is safe from remote access/hacking.
Source Serialized Content File (Style II): This is simply a file that is written to the CD, based on a file list of Serial Numbers generated externally to the system.

There is no encryption given for this. Some of the advantages to this type of file is that the serial numbers themselves can be generated and read by External sources/customers, and the actual size/contents of this file is solely up to the customer themselves, although the file name MUST remain consistent, UNLESS the CD is NOT to be used with the Smarte Authentication™ System, but an external entity authentication system.
Source Serialized Content Retention: This is information retained by the system that is mapped/linked to the Serialized Label ID/Content file, based on a file list of Serial Numbers generated externally to the system. Some of the advantages to this type of file is that the serial numbers themselves can be generated and read by External sources/customers, and the actual size/contents of this file is solely up to the customer himself or herself, without impacting the CD file generation parameters. In this case, the 220 Character Serial Number Content File is STILL written to the CD for validation/tracking.
Serialized CD Volume Label: The Volume ID label of the CD itself can be serialized, however the inherent limitation to this is the limited number of characters that can be applied to the Standard Volume Label ID. Note that while Volume ID Serialization can be done ALONE (without Serial Number Content File), without the Content file, the CD cannot be utilized with the Smarte Authentication™ program.
Standard Copy Protection—Prevents most CD Burner copy software from outright duplication of the CD, however, does not prevent “re-mastering” of the contents of the CD. Regardless of whether or not Serialization is included, all compliant CD's maintain a media manipulation technique in order to verify whether or not the disk is an original, or a “copy”. Details of this protection are as follows:
   A single file is “corrupted” at the beginning in order to drive an I/O error from the operating system. The Defect is of sufficient size as to cause difficulties in casual copying practices, as will always generate a failure if a “pre-recording” Test phase is initiated.
   The defect itself is specific to a standard “File”, NOT a physical location on the CD Media itself. The validation software looks for the file, NOT the defect.
   The CD's TOC is unaware of the defective area, and reports correctly the files size, etc.
   The defect created MUST be such that the targeted area is unreadable (none or bad media format) such that it drives a system I/O error.
   File Specifics
      File will ALWAYS be named: MMCVAL3.UNX
      File (prior to defect) size will always be: 46291 Bytes (as reported by TOC)
      Original Content of this file is IRRELEVANT
   Defect Specifics
      Defect BEGINS at the first byte position of the target file (MMCVAL3.UNX), REGARDLESS OF POSITION OF THE FILE ON THE CD.
      Defect Length: 4096 Bytes in Length
      Defect essentially destroys the front end of the file on the CD.
Smarte Authentication™ Original CD validation. Ability to validate whether or not the CD is an original generated CD or a copy.
Additional Content can be added at the end users requirement. Serialized CD's can be produced from “blanks” and a single “master” content CD supplied by the end user.

The Smart Card is a serialized device application of a standard Smart Card in use today. The Smarte ID™ Smart Card as produced by MoveMoney, an example of which is displayed in FIG. 13, is about the size and shape of a standard business or credit card for each of portability. These cards initially, when issued to the External Sources, will contain NO information. Since ALL Smart Card Readers are ALSO Writers, the system has the ability to provide anti-piracy techniques through the use of “secure” Smart Cards, requiring the use of a “password” send to the card in order for the information to be read or altered. If the card can be successfully written to using the proper password, the card is likely an original and not a “forgery”. Since the system can also detect the Type of card, and the type of card requires the password, it becomes virtually immune to successful forgery. The functionality/cross application utilization of the Smart Cards are limited by the current lack of industry standards regarding the embedded chips themselves, so the system and External Sources need to set up a “Smart Card Cross Reference” usability chart for External Sources to refer to as the varying Smart Cards are incorporated into the system. In addition, due to the current lack of “standards” regarding the Smart Cards themselves, the “type” of Smart Card itself must be maintained within the system, as programming/API calls/etc will vary from one individual card type to another.

The Soft ID is a program, file, or combination of these that reside on a particular machine, and allow the system to identify the individual, as being allowed to access from either a single or multiple machines. Typically, these forms of identification are no as strong inherently as a physical authentication device, as they are relegated to the machine, and are as accessible for identity theft as the Soft ID is able to be copied or moved from the individual machine, or access to the individual machine is gained by an individual having the real user's password. Despite these factors, they are used, so the Smarte System™ is structured/designed to allow for their usage.

The 3^{rd} Party Device type is any device, system, or combination of such that functions in a manner to physically authenticate a user's identity. Devices, such as RSA's SecurID™, rely not only on the device itself, but also on proprietary system's from which the validation occurs. In order to utilize such devices and systems within the Smarte Authentication™ System, the system is designed to interact with external systems via these external system's “plug-ins” or equivalent interfaces. In this manner, a user can utilize the physical device of a third party, without having to purchase or maintain the operating system behind it, utilizing the Smarte Authentication™ System as the portal for validation instead. An example of such a device (RSA's SecurID™) is shown in FIG. 14.

System Flow

There must be a mechanism to access and interface with the individual Seller's systems in order to provide the Buyer Interface between the Seller's System and the Smarte System™ There are various models and methodologies regarding the manner in which this interface is accomplished. Rather than create a series of scripts that are added to the Seller's system in order to interface with the multitude of individual “check-out” programs, both third party and “custom”, it was determined that a better way to accomplish this was to DIRECTLY interface with the Seller's system itself. In addition to this unique platform, a secondary version of the platform that was designed solely to facilitate the payment itself, without any of the other capabilities. This, in effect, gives the Seller's additional options on how they want to set-up and interact with the System.

The Smarte Authentication™ System Plugin can be segregated into two basic functional classifications as User Authentication and Product (CD Based Media Distribution).

User Authentication is utilized as a third layer of access security to help positively identify the user, and to validate that the user is in fact, not another individual posing as that user. There are 4 requirements within the system, regardless of application or utilization logistics that are required in order for the device/auth/system to function:
1. Device must be physically in the hands of the end user.
2. Device must be attached/assigned to the individual end user in the SA system.
3. Access Authorization must be attached to the device.
4. Device must be activated (End user identity verification—entered into the system)

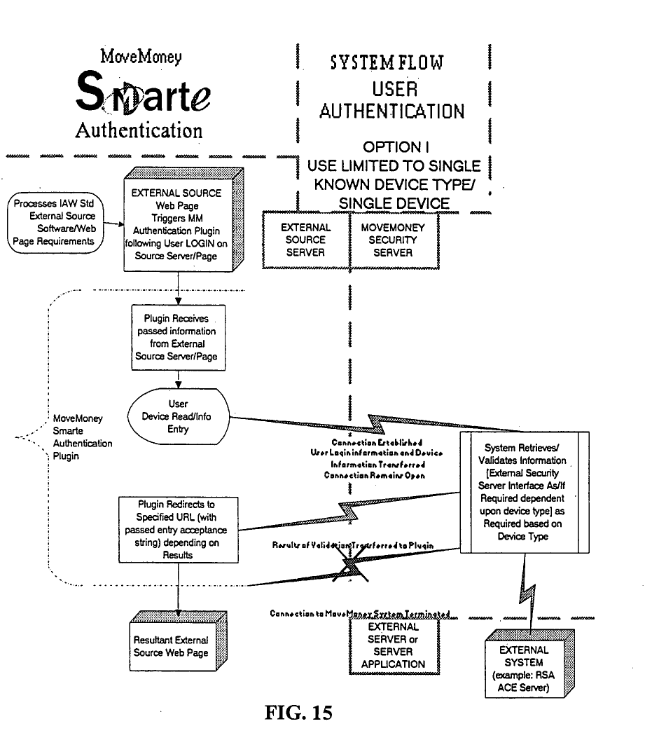

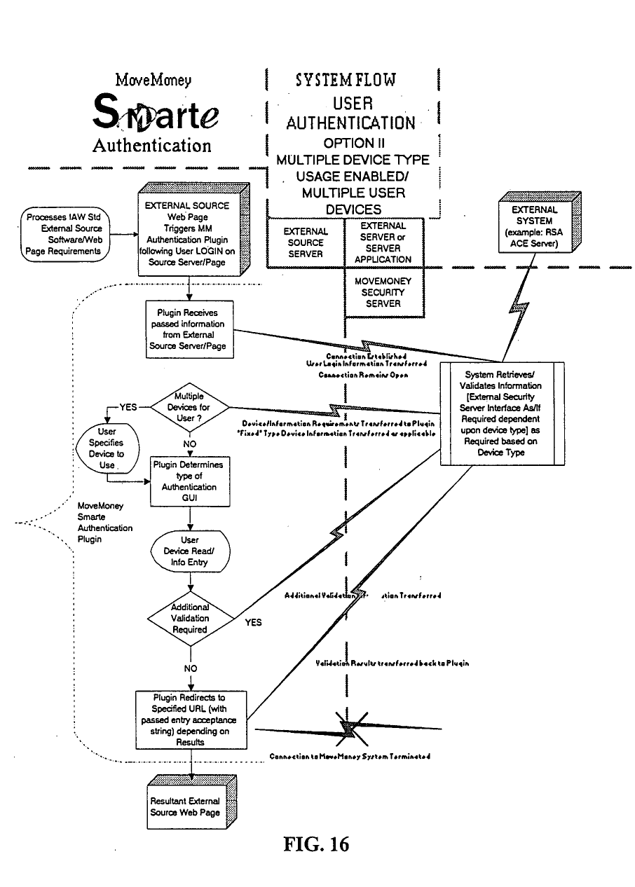

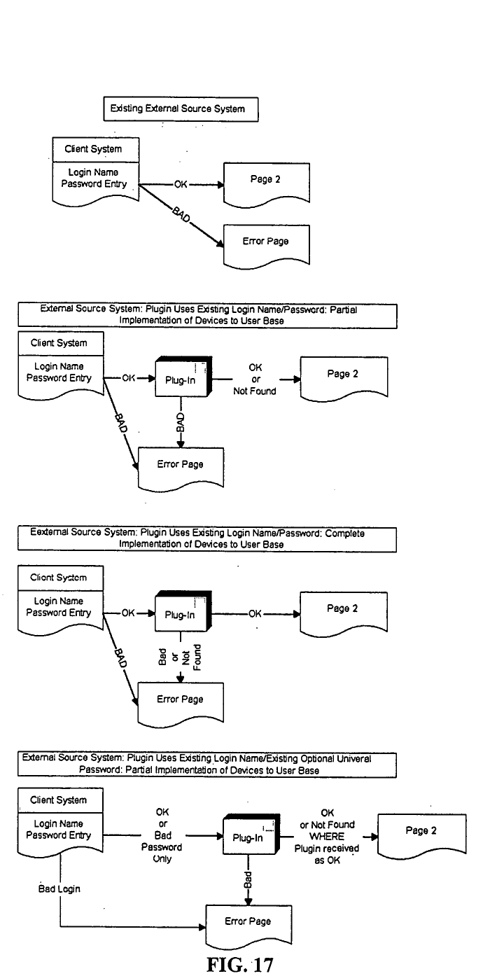

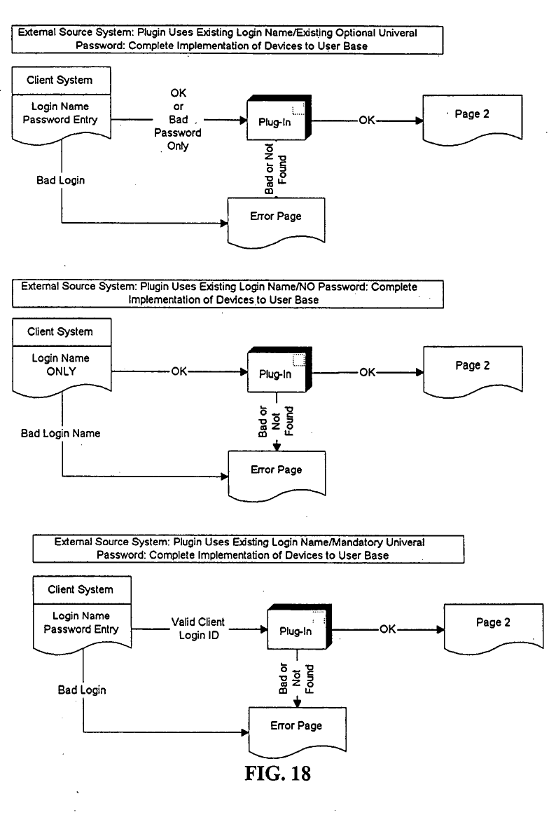

One of the requirements for the User Authentication to be effective rests with the external user, and the design/set-up of their system. If the Authentication is to act as a prevention of unauthorized access, then the external source system MUST prevent users from being able to “bookmark” and enter areas of the system directly, that are “behind” the access/login screen. User Authorization falls into two separate categories. This is done to highlight the varying complexities required to be maintained between the capabilities of the two systems. Option I is the simple form of the usage of the system. Under this category, each user maintains only a SINGLE device, of a single FIXED type utilized by the external user. An example of this would be a business, whereby they have chosen to utilize ONLY Smart Cards within their organization. Each user within this organization can only gain access through THAT particular Smart Card, and each user is only issued a SINGLE card. Note that this option is anticipated to be more common for organizations utilizing the system to validate user access for internal systems, rather than those systems that are exposed to the general public. This feature does not prevent the user from maintaining MULTIPLE devices, it simply limits the access to the particular external source. This Plug-in option functions independently of the User's maintained devices, however, this option, when elected by the source, prevents the “mapping” functionality of the Smarte Authentication™ system. The basic flow within a system utilizing Option I (refer to FIG. 15) is as follows: When a user accesses a site that has the Option I Type Smarte Authentication™ Plugin incorporated, the site passes the user's login and password information to the Smarte Authentication™ Plug-in. The Plug-in establishes a link to the Security server, and passes the user's password and login, the source id, and device information to the Security Server for validation. All of this information is possible in one pass, as there is only a single device type, the requirement for information/device read is already known, and can therefore be requested/obtained at the time of login. If Physical Device validation is required, it is also performed prior to the transmission of information. Once the Security Server receives this information, it validates against the information stored on the server within the user's profile. Regardless of results, information is then transmitted from the Security Server to the Plugin, which then takes appropriate action in redirecting the user to a new address depending upon the results returned, based on the settings previously stored by the external source administrator. If the validation of the information passed requires that an external security server or program be accessed, it is done so from the Security Server, and NOT by the Plugin independently. Option II is the more complex model, and takes into account the ability of an external system to recognize multiple device types, as well as the fact that the user themselves may maintain more than one device with which to access the system. The flow for Option II is as shown in FIG. 16. The initial requirements and resultant action for Option II is the same as with Option I except for the additional complexity requirements. At the point of User Login, there is NO device interaction, as the TYPE of device is NOT known. Therefore, only the Plugin Source Identification, and entered Login/password are transmitted to the Security Server. Once the user is identified via the source and Login information, and password is validated, device information is then transmitted back to the Plug-in for ALL available types of devices. IF the user has multiple devices available to them for the identified SOURCE, then a screen is presented to the user to select device type to use. Once the type of device to use has been identified, validation of the device is then performed, with the condition that if the device validation is not a fixed type, OR requires an external server/system in order to validate the data, the information must then be transmitted BACK to the Security Sever to handle the additional validation step. If this occurs, the results of the validation are then passed back to the Plug-in. If additional transmission/validation is not required, then the Plugin itself can validate the information from that previously transmitted based on the device type. In addition to the Option I and Option II application methodologies, there are additional methodologies that can be employed by the External Source depending upon their individual requirements. These basic application variant scenarios are displayed in FIG. 17 and FIG. 18. These variations to the application of the Smarte Authentication™ take into account whether the External Source has required ALL of their users to utilize a device, or only a partial number of them, (such as in an initial pilot or test program), whether they have decided to allow the use of “universal passwords” as an option, or even if they have chosen to have the Smarte Authentication™ system handle ALL of the access requirements, including the maintenance of their user base and subsequent handling of periodic or access fees via the Smarte System™ Fees and Commissions capability.

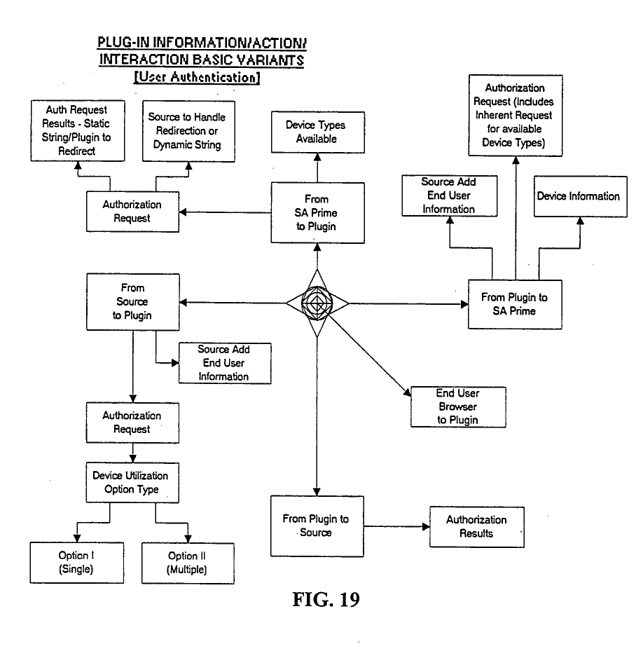

The Plugin, regardless of the application, passes information between the Smarte Authentication™ portion of the system and the External Source Page, as well as collect information from the End User. The Plug-in acts as the information “hub” of the Smarte Authentication™ portion of the Smarte System™. Information Requirements are depicted in FIG. 19. For the purposes of clarity, within FIG. 19 and within the following listing, the term “SA Prime” refers to the Smarte Authentication™ System portion of the Smarte System™ residing on the Server and not the Smarte Authentication™ Plug-in. Information passed in the various segments depicted in FIG. 19 is as follows:
Passed Information Requirements: Source to Plugin
   Source Adds End User to System
      External Source SA System ID
      End User Login Name (or other Unique Identifier for the End User for that particular External Source
      Personal Identifier Information #1 (Optional—Use depends on Source Activation Requirements)
      Personal Identifier Information #2 (Optional—Use depends on Source Activation Requirements)
      Existing SA System ID for User (if exists/known)
      Personal Information (Optional)
         Name Prefix
         First Name
         Middle Initial
         Last Name
         Name Suffix
         Address Line #1
         Address Line #2
         City
         State
         Zip Code (5)
         Zip Code (4)
         Voice Telephone #1
         Voice Telephone Ext (#1)
         Voice Telephone #2
         Voice Telephone Ext (#2)
         Email Address
         SSI#
   Authorization Request
      External Source SA System ID
      End User Login Name (or other Unique Identifier for the End User for that particular External Source that was previously passed to the SA system
      SA System ID for applied Access Authorization
      “0” if Single Device/One Device for user Known (External Source Sets up as an internal requirement); or “1” if “standard” utilization
      “2” if Password passed to system”, “3” if not
      “4” if Dynamic URL passed, “5” if not
      “6” if Dynamic Strings Passed, “7” if not
      Connection/Session ID/Request Number
      If Single Device Type known:
         Code indicating expected type of device
      Password Passed (Optional usage/utilization depending on Universal Password Override/Usage)
      If Plugin WILL handle Redirection utilizing Dynamic variables, the following information is required [Note: This information is retained by the Plugin and not passed to the SA Prime]:
         If Dynamic URL:
         URL to Redirect to if good
         URL to Redirect to if bad
         URL to Redirect to If Not Found
         If Dynamic Strings to be passed
         String to Pass if good
         String to Pass if bad
         String to Pass If Not Found
Passed Information Requirements: Plugin to SA Prime
   Source Add End User Information
      External Source SA System ID
      End User Login Name (or other Unique Identifier for the End User for that particular External Source
      Personal Identifier Information #1 (Optional—Use depends on Source Activation Requirements).
      Personal Identifier Information #2 (Optional—Use depends on Source Activation Requirements)
      Existing SA System ID for User (if exists/known)
      Hash Value
      Personal Information (Optional)
         Name Prefix
         First Name
         Middle Initial
         Last Name
         NameSuffix
         Address Line #1
         Address Line #2
         City
         State
         Zip Code (5)
         Zip Code (4)
         Voice Telephone #1
         Voice Telephone Ext (#1)
         Voice Telephone #2
         Voice Telephone Ext (#2)
         Email Address
         SSI#
   Device Information
      External Source SA System ID
      Connection/Session ID/Request Number
      End User Login Name (or other Unique Identifier for the End User for that particular External Source
      Code indicating type of device
      Serial Number of Device (Encrypted String as Read from Device)
      Anti-Piracy Result Code: “0”—Pirate Copy Determined; “1” Valid Device; “2”—Not Determined
      SA System ID of Device
      IP of User (if captured)
      Hash Value
   Authorization Request
      [Note: Dynamic Strings are retained by the Plugin, but are still passed to the SA Prime for Log retention]
      External Source SA System ID
      End User Login Name (or other Unique Identifier for the End User for that particular External Source that was previously passed to the SA system
      SA System ID for applied Access Authorization
      “0” if Single Device/One Device for user Known (External Source Sets up as an internal requirement); or “1” if “standard” utilization
      “2” if Password passed to system”, “3” if not
      “4” if Dynamic URL passed, “5” if not
      “6” if Dynamic Strings Passed, “7” if not
      Connection/Session ID/Request Number
      Hash Value
      If Single Device Type known:
         Code indicating expected type of device
         Device Serial Number (String)
         Anti-Piracy Result Code: “0”—Pirate Copy Determined; “1” Valid Device
      Password Passed (Optional usage/utilization depending on Universal Password Override/Usage)
      If Plugin WILL handle Redirection utilizing Dynamic variables, the following information is required [Note: This information is retained by the Plugin and not passed to the SA Prime]:
         If Dynamic URL:
         URL to Redirect to if good
         URL to Redirect to if bad
         URL to Redirect to If Not Found
         If Dynamic Strings to be passed
         String to Pass if good
         String to Pass if bad
         String to Pass If Not Found
Passed Information Requirements: SA Prime to Plugin
   Device Types Available
      External Source SA System ID
      Connection/Session ID/Request Number
      End User Login Name (or other Unique Identifier for the End User for that particular External Source
      Code Block indicating type of device
         (Examples: for a CD only: “0” for a CD and Smart Card: “02”; for a CD; Smart Card; and Secure Concepts Token: “025”; for Two (2) CD's and Two (2) Smart Cards with One (1) RSA token: “00224”
      Code Block indicating SA System ID's for specific Devices Available—Listed in same order as in Code Block for type of device
      Indication of whether Anti-piracy Techniques to be utilized by the Plugin
      Hash Value
   Authorization Request [Results]
      [Note: Dynamic Strings are retained by the Plugin, but are still passed to the SA Prime for Log retention]
      External Source SA System ID
      Connection/Session ID/Request Number
      End User Login Name (or other Unique Identifier for the End User for that particular External Source that was previously passed to the SA system
      SA System ID for applied Access Authorization
      Code indicating Results of Authentication
      Code to indicate whether or Not Plugin to perform redirection
      If Plugin WILL handle Redirection utilizing STATIC variables, the following information is required [Note: If DYNAMIC variables used, plugin has retained these and they do not need to be passed back]:
         If STATIC URL:
         URL to Redirect to based on result of Authentication
         If STATIC String to be passed
         String to Pass based on result of Authentication
      Hash Value
Passed Information Requirements: Plugin to Source
   Results from Authorization Request (Source to handle redirection)
      External Source SA System ID (Validation)
      Connection/Session ID/Request Number
      End User Login Name (or other Unique Identifier for the End User for that particular External Source that was previously passed to the SA system
      SA System ID for applied Access Authorization
      Code Indicating Results:
      “1”—Bad
      “2”—Not Found
      “3”—Good
Passed Information Requirements: End User Browser to Plugin
   [Content dependant upon type of device]
   IP of User

Within the system, there is a need for a viable, cost-effective two-factor end-user authentication solution to secure its own e-payment infrastructure platform, such as Smarte Pay™, from front-end identity assumption. Available market solutions were either too cost prohibitive or too cumbersome from an implementation perspective to suit the platform's specific needs. As a result, the inventors began to develop its own authentication solution, eventually known as Smarte Authentication™, for integration into Smarte Pay™. The success of the Smarte Authentication™ concept was dependent upon the development of a physical authentication device that would be suitable for mass deployments to millions of end-users. The best possible device format was the CD-ROM as it offers both extreme affordability and wide-scale availability for end-user use. Of course, integrating a strict anti-forgery mechanism into the device media would be key to making CD-ROMs a viable end-user authentication vehicle. Research and development efforts in this area produced a unique media-based copy-protection and embedded serialization technology that is used in its own CD-ROM end-user authentication devices. The present invention extends this anti-piracy technology for industry-wide use by software developers and manufacturers.

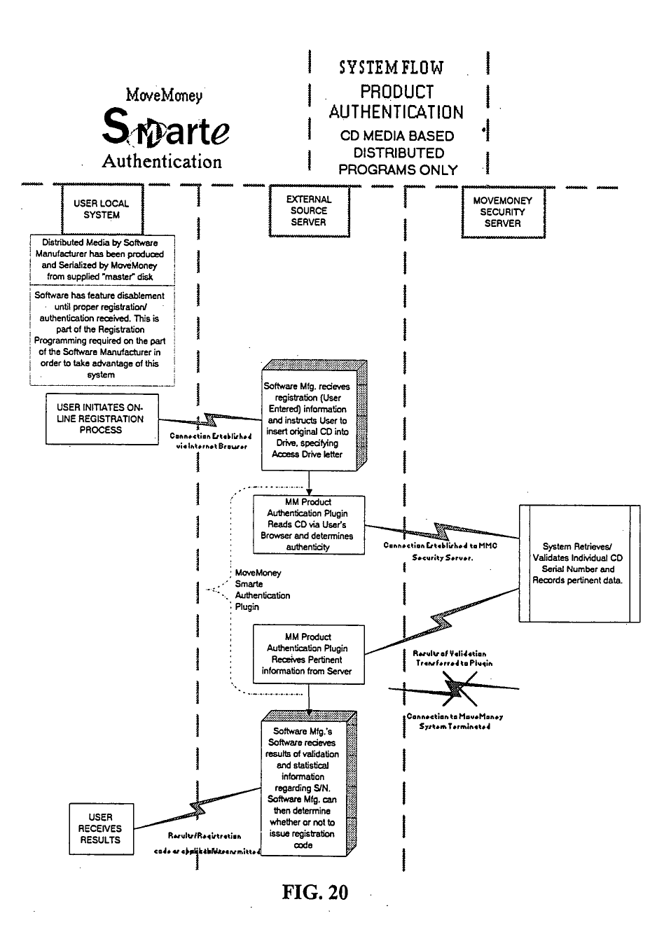

Product Authentication, is a set of tools that is provided to Software Manufacturers in order to primarily assist in combating/eliminating moderate to large scale piracy of software distributed via CD-ROM or the Internet or similar wide area network (electronic distribution). Product Authentication is designed to be exclusive to MS/IBM DOS Based/Microsoft Windows applications only, at this time. Product Authentication is designed to allow software manufacturers the ability to prevent medium to large-scale piracy of their programs when either a CD-ROM or the Internet is the distribution vehicle. Note that there are certain modifications required by the software manufacturer to make this a truly effective method of anti-piracy, however the methodology portrayed here can be only partially implemented depending on desired outcome and requirements. One of the primary basic premises that the software manufacturer must make to have this methodology become effective is that they WILL have to make coding changes to the software itself at some point, in order to FORCE the user of the software to REGISTER the software, preferably, on-line via the Internet. Current Anti-piracy methods completely fail, as even copy-protected CD's can be remastered/duplicated, and even the best protection can in many ways be FORGED. For example, Microsoft issues a CD “KEY” that must be entered when the software is installed. However, a set of byte for byte replicated disks, along with a written reference to the CD Key that was provided with the originals, is all that is required to have a fully functional “original”. Another method that is currently employed, is that the original CD is required to be present in the CD drive DURING the program operation, however, this again fails as a “remastered” CD in virtually all cases is enough to allow the program itself to operate. It is what is known as “Shareware”, which has been around for many years, that has actually provided part of the answer here. Shareware, typically, is a program that is designed to be freely distributed, however within the program itself, there are either certain feature limitations, or a “system fail” date/time period, which essentially allows a user to “try” the system for a specific period of time. When the User REGISTERS the software, they are given a “registration code”, of which receipt and entry of the code into the registration screen of the software UNLOCKS the software. If the Software manufacturer were to adopt a similar principle in their “standard” issued software packages, REQUIRING registration, coupled with the unique serialization of the distribution media, can virtually eliminate Piracy of the software. In addition, where the distribution software contains MULTIPLE CD's, ALL of the CD's within the individual installation “set” can be set to contain the same anti-piracy features as the initial CD, along with the SAME serial number for each CD within the specific installation “set”, making it even more difficult to duplicate/re-master ANY of the installation set CD's. There is also to be supplied a “manual” entry/access screen for the software manufacturer in order to manually work with registrations as well. The Security Server retains a listing of the Serial Numbers assigned to all of these individual CD's. In doing this, when the software is registered, that Serial number is then recorded. Since the serial numbers are now tracked statistically, this gives the software manufacturer the ability to set a “registration” threshold setting within the system. Since validation response is aware of this threshold, the Security Sever can then respond back to the Software Manufacturer Registration web site (via the Plugin) or manually (via the GUI) the results of the validation. Since the limitations are themselves embedded within the Manufacturer's code, and can only be unlocked via the registration number issuance (which can actually be based on an algorithm to match the individual Serial Number) as well as a consistent factor that changes, such as an embedded value representing the System date, which therefore makes every installation registration code unique. Again, the level of prevention is completely up to the Software manufacturer, however the system can provide them the means to accomplish this. The basic flow of the Product Authorization system, as used to it's full extent/capability, is shown in FIG. 20.

Smarte Product Authentication™ offers software manufacturers/publishers a flexible and cost-effective piracy management infrastructure and is ideally suited for the protection and promotion of multi-license enterprise software as well as individual consumer-licensed applications distributed on CD-ROM. For product and business environments that do require a rigorous ‘anti-piracy’ solution, Smarte Product Authentication™ can provide the strictest possible protection to an application distributed on CD-ROM, eliminating virtually all common piracy of the product. Smarte Product Authentication™, though, differentiates itself from alternative anti-piracy solutions in its flexibility of implementation. Because the infrastructure is comprised of four distinct tools that can be used in different combinations and with variable underlying strategies, the resulting piracy management can be tailored to fit company and product specific user base objectives. By uniquely managing piracy through Smarte Product Authentication™, software companies can exploit piracy to their economic benefit—maximizing piracy's positive contributions and minimizing its negative effects. Because the piracy management tools do not require additional hardware or devices, the system can enable an extremely sound, cost-effective and mass-deployable solutions.

Piracy Management Tools Offered through Smarte Product Authentication™

Flexible Copy Protection

Through a media manipulation technology, the present invention protects software applications distributed on CD-ROM media. The present invention offers software manufacturers a cost-effective anti-piracy solution that resides entirely within the CD-ROM media itself. This base level of anti-piracy technology distinguishes the contents of an original, properly licensed CD-ROM from a forgery. With this solution, software manufacturers can effectively render unusable virtually any forged application CD-ROM. Alternatively, this solution allows software manufacturers the flexibility to rigorously protect certain features and/or applications while freely allowing the re-distribution of other features and/or applications contained on the same CD-ROM.

At the point of product production (either replication or duplication), the present invention alters the CD-ROM media in a way that cannot be duplicated or digitally reproduced by most CD-ROM writer hardware and software. The present invention has the necessary code for integration onto the CD-ROM media whereby the originality of the CD-ROM can be efficiently validated. The present invention encrypts and embeds this code during production of the product CD-ROM. The application to be protected can be developed with calls to this originality validation routine. The technical parameters of the routine (a DLL) are made fully available to the client's development team(s) to ensure seamless use of this tool. The DLL can be called at whatever point or points a particular application needs to validate the originality of the CD-ROM. When called, the DLL either confirms that the CD-ROM is a valid, original CD-ROM or determines that it is a not a valid, original CD-ROM. This key information is then passed back to the application, which would then carry out the appropriate action in line with the software manufacturer's piracy management objectives. Knowing that the media is a valid original or an illegitimate copy provides great flexibility to the manufacturer of the application to do any of the following based on that key knowledge:
Allow a complete install plus a marketing driven bonus (in the context that the bonus would provide something to a legitimate purchaser that would not be made available to the pirate user).
Allow a standard complete install.
Block an install effectively rendering a pirate copy useless.
Allow a time based install that would render the application useless after a certain period of time.
Allow only a partial install of the application effectively limiting its use (until, perhaps, the pirate user legitimately registers and pays for full use of the copy).

Embedded Product Serialization

The present invention, also at the point of product replication or duplication, can uniquely encrypt and embed an identifying serial number within the content of each individual product CD-ROM. As an extension of this procedure, the present invention has the ability to add essentially any other unique content desired by the software manufacturer (such as company specific serial numbers) to individual CD-ROMs. The uniqueness that serialization provides to an individual CD-ROM makes the product a traceable identifier of the original purchaser. Product serialization provides the basis by which use of an individual product (whether its an original or a duplicated copy) can be tracked and managed via the Internet.

Internet-based CD-ROM Reads

As piracy management allows for the individualization of distributed software products, the tool developed to take advantage of this capability is an Internet-based product read. Through any standard web-browser, the serial number can be read from the CD-ROM and, therefore, tracked. Foreseeable online interactions between the product user and the software manufacturer naturally involving the product CD-ROM include online registration of the product, product upgrade downloads, product patch downloads, product documentation downloads, customer service inquiries, license renewals, license upgrades, payment to render a pirated copy or feature ‘legitimate’, and use or unlocking of any marketing ‘extras’ the software manufacturer may choose to include with the product.

Beyond providing the link to track the use of individual product CD-ROMs, this tool facilitates the use of serialized CD-ROMs as user authentication access keys in direct support of a web-based direct sales model. The product CD-ROMs can, in effect, become unique identifiers for individual purchases made during future Internet based transactions conducted through the software manufacturer's (or designated agent) website. As an authentication key, serialized CD-ROMs serve to protect the online identity of the purchaser as well as provide the software manufacturer with strong transactional non-repudiation (protection against Internet-based identity fraud).

The full product purchased by the customer could contain several applications in addition to the intended purchase. Even though burned as full products onto the CD-ROM, these additional applications could be presented to the customer in limited formats such as demo packs or trial versions. Accompanying license information could also be bundled with these additional applications. The customer could then choose to directly purchase any of these additional products (via the Internet). At the time of purchase, the software manufacturer would generate and return to the customer a digital key (based upon the serial number contained within the CD-ROM, a time factor, and a factor unique to the software manufacturer) in conjunction with the presence of the CD-ROM itself to unlock the application and its appropriate license.

A Utility for the Protection of Downloadable (Electronically Distributed) Applications

The present invention can provide the necessary infrastructure (an enhanced Dynamic Link Library) to generate a unique authorization code (an encrypted number) based on elements taken from each of the following: the unique serial number contained in any serialized CD-ROM possessed by the customer, a time factor, and a factor unique to the software manufacturer. The validity of this generated authorization code can be time-limited (by date, for instance) to prevent its unauthorized sharing with respect to the application it serves to unlock. The customer would then use this authorization code (within the specified time limit) in conjunction with the serialized CD-ROM to enable an install of the application. Beyond the act of installation, the software manufacturer could further support the integrity of the application with other piracy management tools such as Internet-based installation tracking and/or additional CD-ROM originality validation checks during use of the product. Because Smarte Product Authentication™ strongly supports the protection of electronically distributed software, use of the CD-ROM as a primary source of product distribution can be eliminated.

Marketing/Sales Opportunity Enablement

CD-ROM serialization and protection methodologies enable the software manufacturer to be as creative as possible when distributing or marketing software products. Some marketing applications enabled by Smarte Product Authentication™ are outlined in the following:

Bundling of Products on Distributed CD-ROMs

The software manufacturer can bundle any combination of full products, limited-use versions, trial versions, demo versions, and license packs on the same CD-ROM (capacity-limited) or set of CD-ROMs. These product types can be distributed in conjunction with purchased applications or simply as enticements to purchase. Customers or potential customers can easily and efficiently purchase and register the product online through the software manufacturer (or its designated agent) as well as receive the means necessary to gain access to the purchased application.

Increased Online Customer Interaction

Several piracy management features could promote the online interaction between the software manufacturer and its customers. Increased online interaction translates into increased direct sales opportunities as well as increased knowledge about the user base, which can then be used to further enhance marketing strategies.

Regional Product Targeting

The software manufacturer can develop and distribute product bundles based on regional demographics and competitive landscapes.

Application Rentals

The use of piracy management tools enables the rental of applications and application licenses both through electronic distribution and through traditional brick-and-mortar outlets. As the tools provide for use-of-application tracking and control, software rental marketing schemes become viable, protectable options for the industry.

Eliminates the Need for Easily Re-distributable License Diskettes (Enterprise Software)

Because multiple unique content files can be embedded within product CD-ROMs, piracy management can be used to eliminate the need for enterprise software manufacturers to use floppy diskettes as the (unprotected) medium for distributing license related serial numbers and encryption keys.

The CD-ROM containing the enterprise application can be burned with the necessary enterprise license related serial number and unique encryption key in addition to the present invention's unique serialization of the CD-ROM. In this manner, the CD-ROM would become the only media the enterprise customer would need to maintain as it contains both the application and the necessary license information.

The unique license information can be burned on a serialized CD-ROM separately from the application. This would, in effect, replace the enterprise software manufacturer's current use of the floppy with a protected CD-ROM. The enterprise customer would still maintain an application CD-ROM along with another CD-ROM containing the license information for that application. This scenario would enable the application CD-ROM to still be burned without media manipulation and, thus, allow it to be archived by the customer.

Even though protected from unauthorized copying, original license-containing CD-ROMs would still be vulnerable to ‘sharing’ between companies without further protocol. The present invention's piracy management technology can be used to track the number of installations by unique product serial numbers. This would require an online interaction (perhaps during product registration) between the application manufacturer and the legitimate purchaser of the product in order to record the application's legitimate installation. With this knowledge, the manufacturer can choose to deny further installations of the same original product beyond legitimate customer service related issues.

Separately or in addition to installation tracking, the software manufacturer could choose to require a simple media originality check to be performed by the enterprise application to ensure the user owns a valid, original license and/or application. These checks could be required periodically (weekly or monthly, for instance) and/or the software manufacturer could choose to require the original CD-ROM to present during general or particular use of the enterprise application. Failure of these checks could be programmed to result in time-delayed termination-of-use of the enterprise application.

Large Scale Product Replication/Individualization

Using a hybrid replication/individualization technology in conjunction with developed management software, the large-scale and highly cost-efficient process of producing serialized product CD-ROMs can be conducted by the production house(s) of the software manufacturer's choice. Alternatively, the present invention does have the capacity to act as a serialized product CD-ROM production house.

Efficient large-scale replication of individualized product CD-ROMs involves a three-step process:

The software manufacturer would supply an import file to the production house containing all unique licensing information (and/or other unique information such as the software manufacturer's product specific serial numbers) that can then be directly read into replication management software along with any common content (the application files, for instance) to be burned onto all CD-ROMs in a particular batch.

All content common to a set of product CD-ROMs is replicated (stamped) from a glass master. A small portion of the CD-ROM media is left open (available for a single post-stamping write to the CD-ROM) for all individualized content.

The CD-ROMs containing the common content are then sequentially written to with the necessary unique content supplied by the software manufacturer (from the import file), the copy protection mechanism, and a supplied serial number (encrypted).

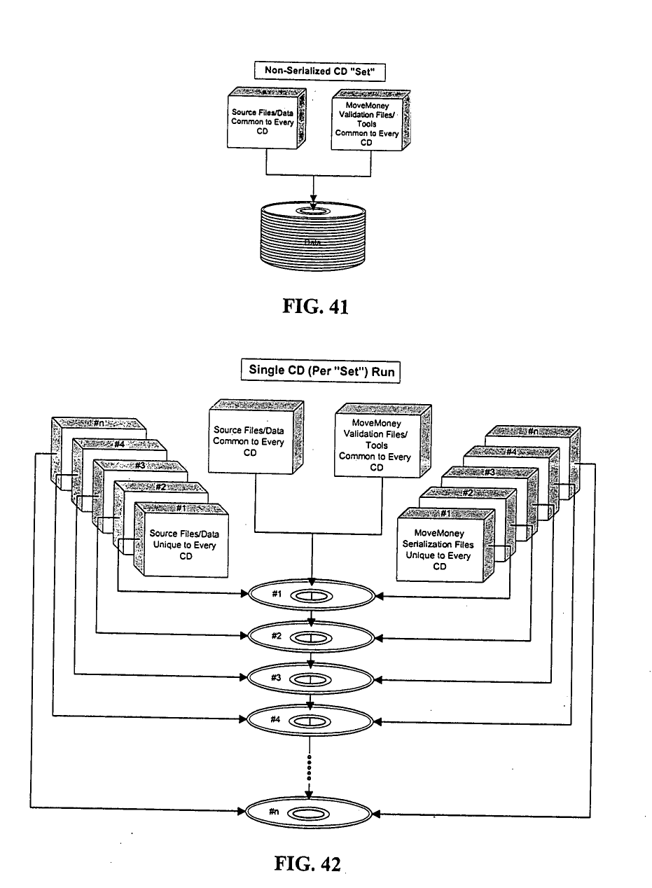

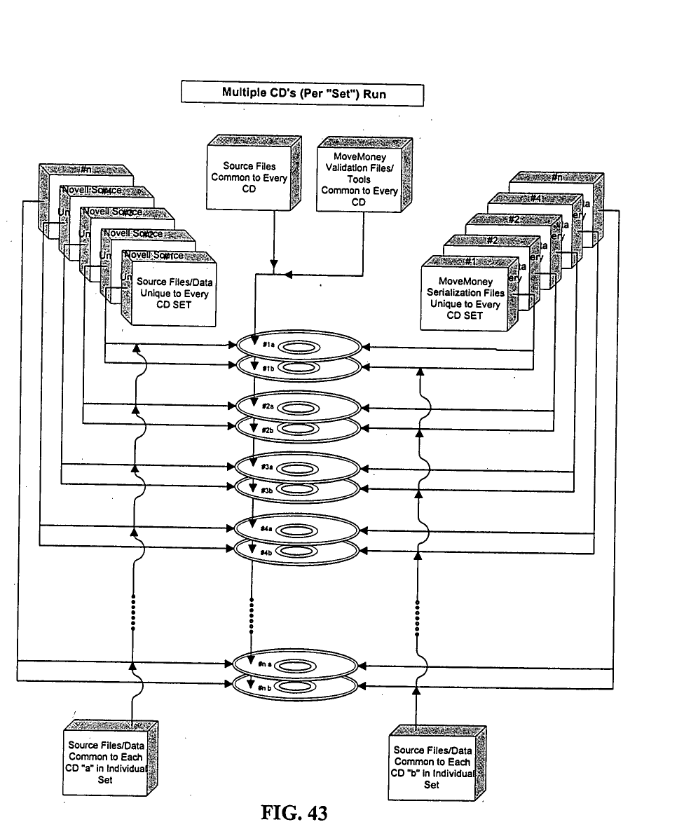

The functioning of developed replication/duplication management software is depicted in FIG. 42 for single set serialized CD-ROMs and in FIG. 43 for sets of serialized CD-ROMs. For non-serialized CD-ROMs containing only the media-based copy protection, the functioning of developed replication/duplication software is depicted in FIG. 41.

Implementation of Piracy Management

Two essential processes would be involved in implementing piracy management technology:

At the marketing level, the software manufacturer would determine how to use piracy management tools within its products/licensing structures to best support its anti-piracy and marketing objectives.

At the application development level, calls to the piracy management tools would be embedded within the product code along with the necessary logic to instruct the application to act accordingly, based on the information the piracy tool(s) pass back. The software manufacturer would determine where and how frequently the use of the piracy management tools occurred within a given application, to best support piracy management objectives.

Enterprise Software Authentication™

Enterprise Software Authentication™ is a tool that enables enterprise software developers to effectively and efficiently create, as a value-add feature, a sound device-based user authentication infrastructure within access sensitive enterprise products. The end result of the methodology gives the enterprise customer the ability to secure access to its software application with strong two-factor user authentication, combining ‘something the user knows’ with ‘something the user physically has’—all without the need for drivers or additional support software.

The devices, which provide the definitive layer of user authentication, are uniquely serialized mini-CD-ROMs, Smarte CD™S. The CD-ROM format delivers affordability, convenient portability, security against forgery, branding opportunities, and complete end-user privacy (no personal information is required).

With this feature, an enterprise software purchaser has a significantly improved ability to effectively manage and control internal access to the software application. Enterprise User Authentication is a strong value-add feature in software application environments where strict access control to the application itself and/or data generated through the application is of prime importance to the business or organization using the application.

Enterprise software application types that would naturally benefit from this user authentication feature include:
Sales & Distribution
Accounting
Investment Management
Materials Management
Human Resource Management
Quality Management
Database Management
Project Management
Network Management
Production Planning

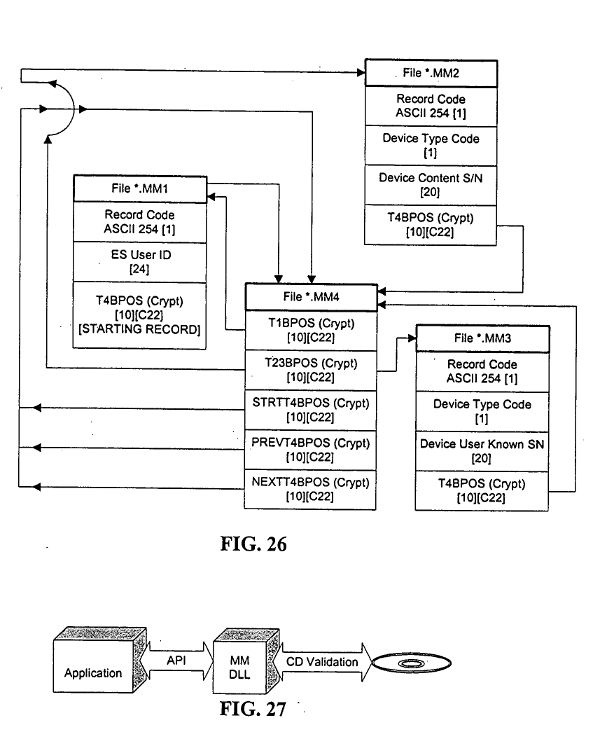

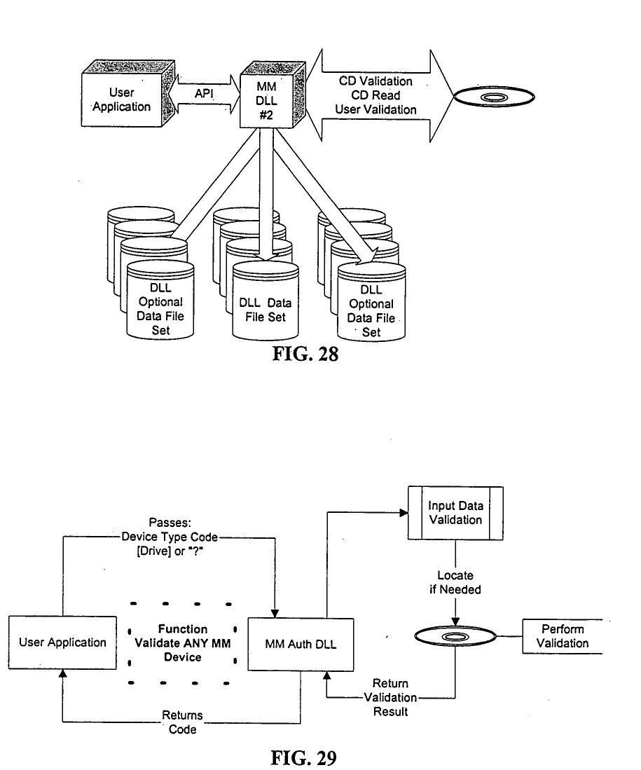

The present invention provides the manufacturer of the software with the necessary tool around which a strong user authentication infrastructure can be built within an application. This tool is essentially an ‘Extended DLL Plug-in’, which serves to create and manage data files governing the user and associated authentication device information. FIG. 26 depicts a diagram displaying the Extended DLL data file structure. FIG. 27 is a flow chart depicting the basic functional flow of the “simple” DLL (media validation function only), while FIG. 28 is a flow chart depicting the basic functional flow of the Extended DLL. An application developed with the Enterprise Software Authentication tool can be delivered with a software-based switch that allows the enterprise customer the option to use or not to use the Enterprise Software Authentication feature. The CD-ROM user authentication credentials can be delivered at the point of sale of the application or at any later date when the enterprise customer chooses to use the feature. Upon the decision by the enterprise customer to use the device-based user authentication feature (and receipt of the devices themselves), the DLL Plug-in, in the context determined by the application developer, provides the means necessary to effectively manage the application's authorized enterprise user base.

Because it is specifically designed as a tool for use at the application development level, the software developer can shape the use of the DLL Plug-in to fit the exact user base access management needs of the enterprise product.

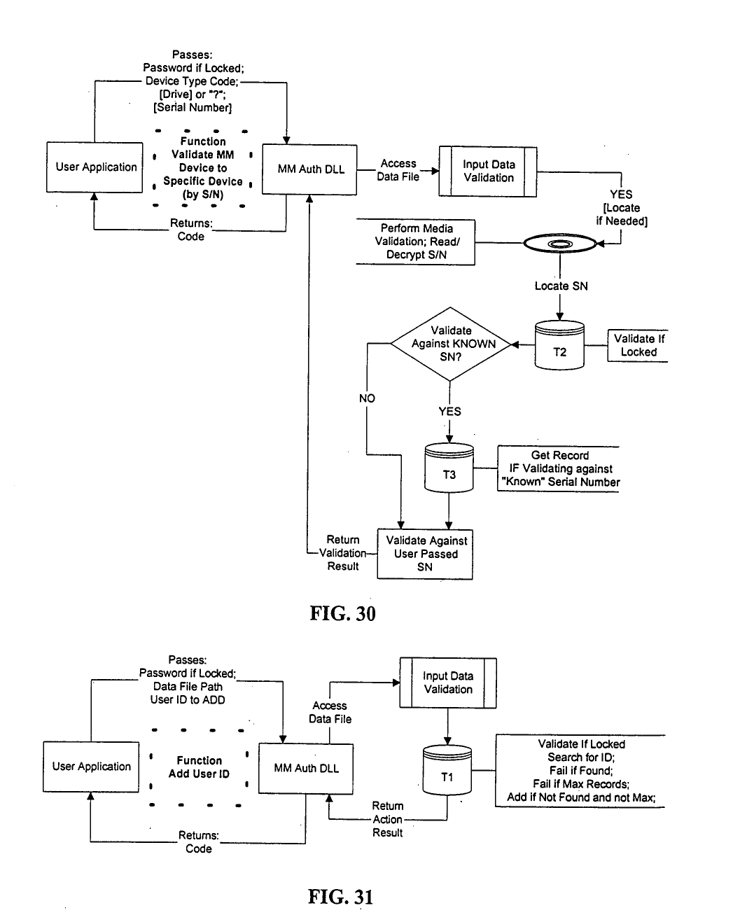

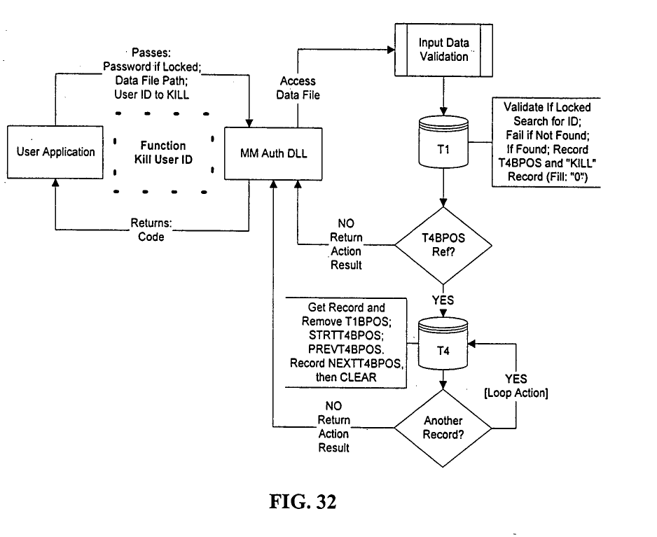

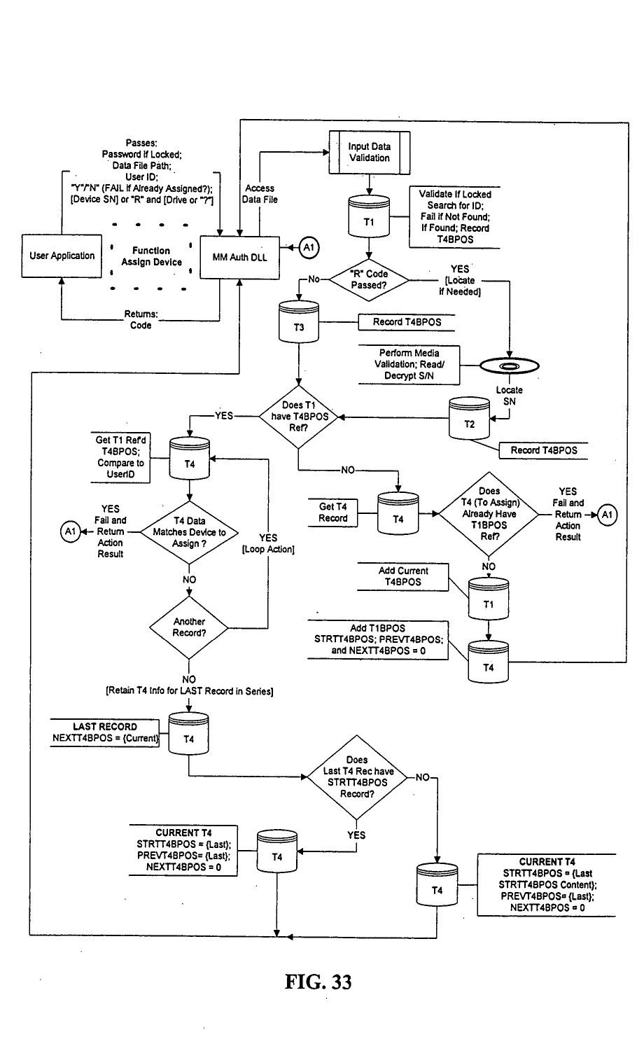

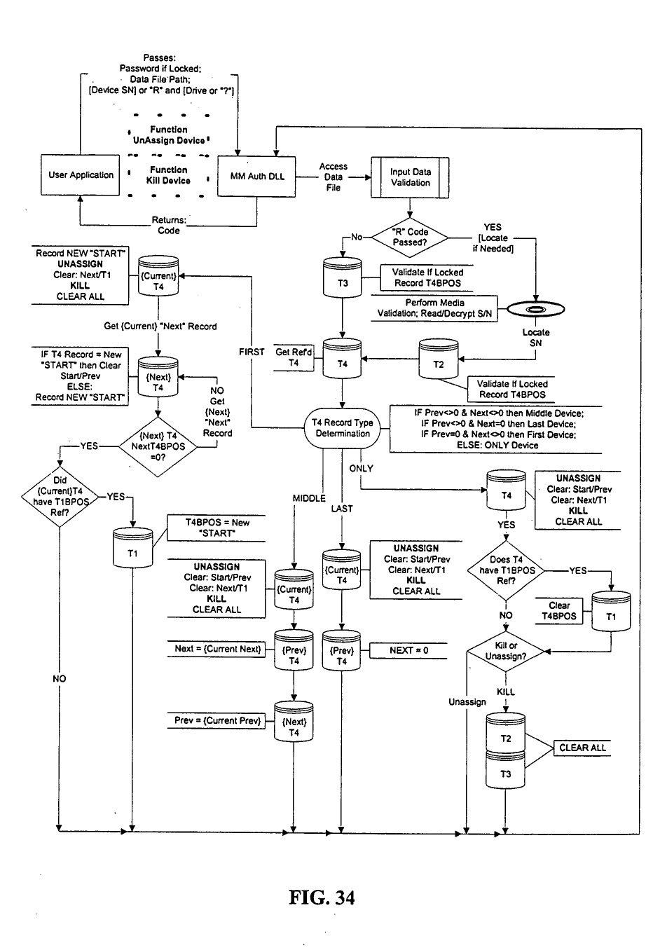

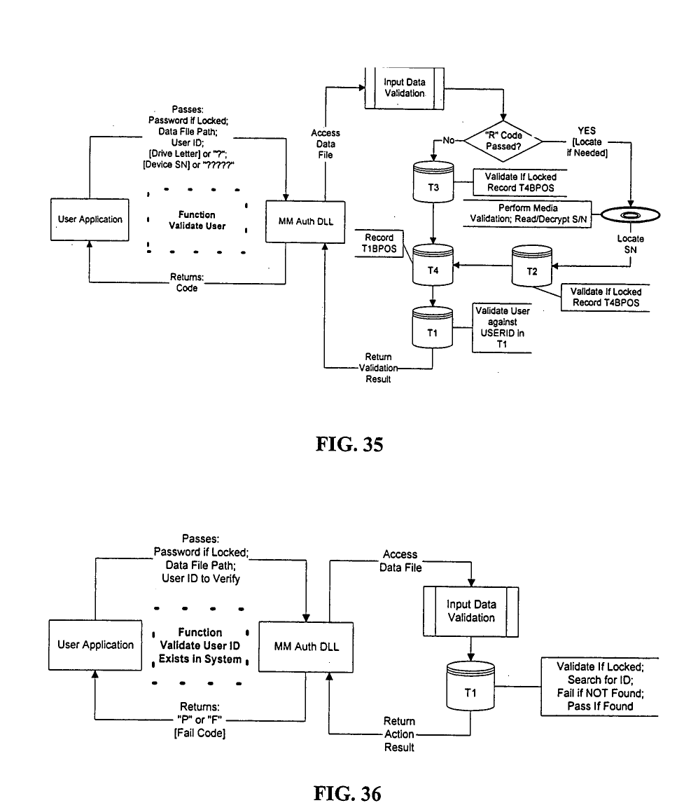

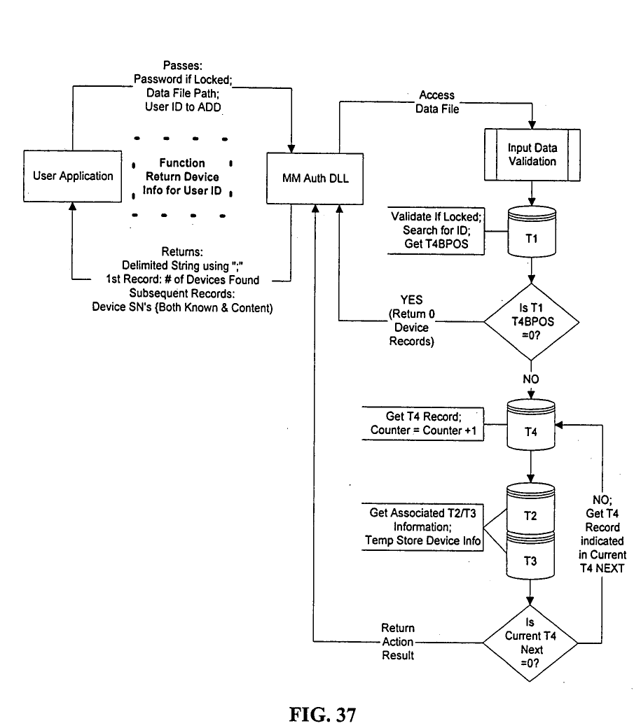

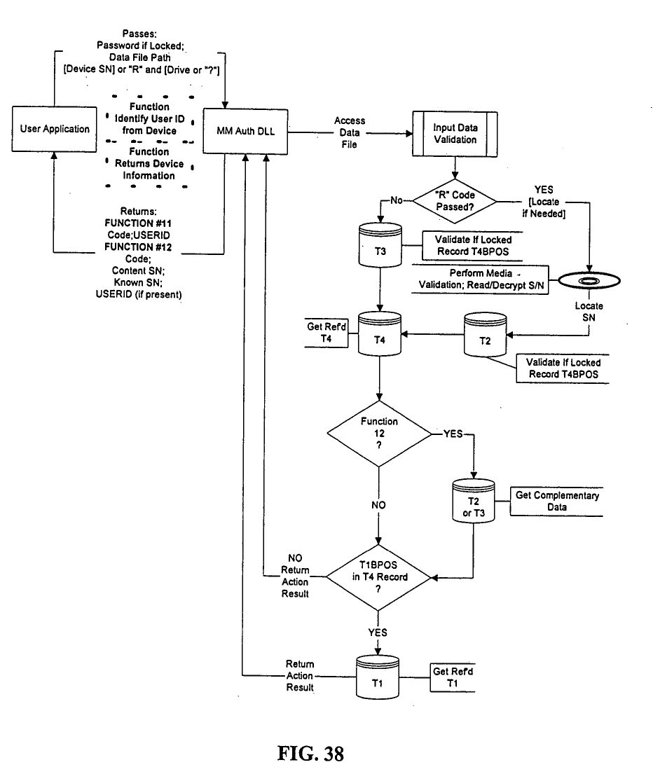

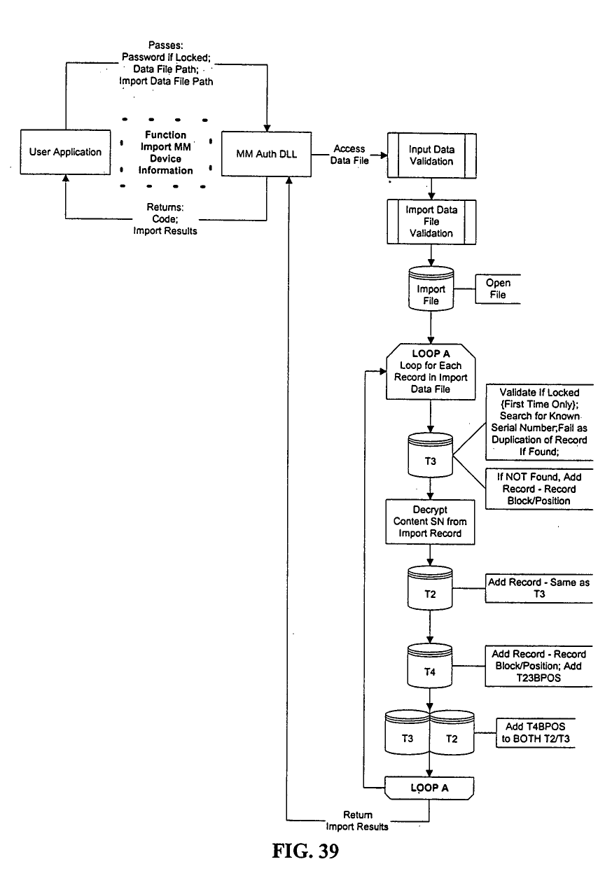

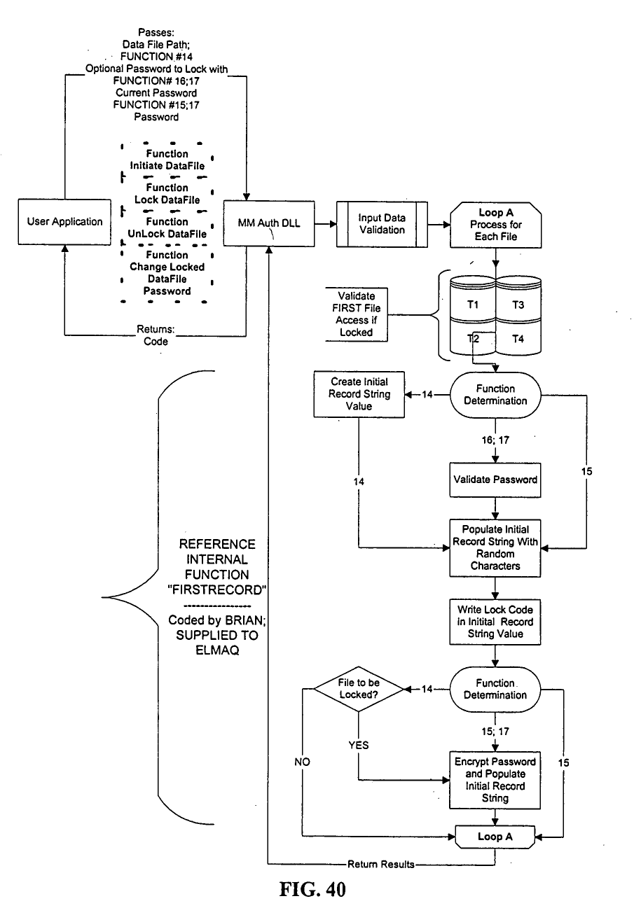

Functions provided by the Extended DLL Plug-in relating to application-driven user authentication are outlined in FIG. 29, FIG. 30, FIG. 31, FIG. 32, FIG. 33, FIG. 34, FIG. 35, FIG. 36, FIG. 37, FIG. 38, FIG. 39, and FIG. 40. The specific code calls and variables/information passed for Visual Basic and C++ are as follows:

```
-----------------------------------
Visual Basic Code Examples
-----------------------------------
ValidateDevice
--------------
Private Declare Function ValidateDevice Lib “SmarteAuth.dll” (ByVal DevCode As String,
ByVal decloc As String, ByVal DeviceDetails As String) As String
Dim Result
Result = ValidateDevice(“0”, “?”, “”)
ValidateSNDevice
----------------
Private Declare Function ValidateSNDevice Lib “SmarteAuth.dll” _{—}
(ByVal DataFile As String, ByVal Pwd As String, ByVal DevCode As String, ByVal DevLoc
As String, ByVal DeviceDetails As String, ByVal SnType As String, ByVal SerialNo As String)
As String
Dim Result
Result = ValidateSNDevice(“c:\movemoney\auth”, “mmcm”, “0”, “?”, “”, 2, “5717M”)
AddNewUser
----------
Private Declare Function AddNewUsr Lib “SmarteAuth.dll” _{—}
(ByVal DataFile As String, ByVal Pwd As String, ByVal UserId As String) As String
Dim Result
Result = AddNewUsr(“c:\movemoney\auth”, “mmcm”, “movemoney”)
AssignDevice
------------
Private Declare Function AssignDevice Lib “SmarteAuth.dll” _{—}
(ByVal DataFile As String, ByVal Pwd As String, ByVal DevCode As String, ByVal
DeviceDetails As String, ByVal SnEntry As String, ByVal DevLoc As String, ByVal SnType As
String, ByVal SerialNo As String, ByVal UserId As String) As String
Dim Result
Result = AssignDevice(“c:\movemoney\auth”, “mmcm”, “0”, “”, “R”, “?”, 2, “5717M”,
“movemoney”)
UnAssignDevice
--------------
Private Declare Function UnAssignDevice Lib “SmarteAuth.dll” _{—}
(ByVal DataFile As String, ByVal Pwd As String, ByVal DevCode As String, ByVal
DeviceDetails As String, ByVal DevLoc As String, ByVal SnEntry As String, ByVal SnType As
String, ByVal SerialNo As String) As String
Dim Result
Result = UnAssignDevice(“c:\movemoney\auth”, “mmcm”, “0”, “”, “E”, “R”, 2, “5717M”)
KillDevice
----------
Private Declare Function KillDevice Lib “SmarteAuth.dll” _{—}
(ByVal DataFile As String, ByVal Pwd As String, ByVal DevCode As String, ByVal
DeviceDetails As String, ByVal DevLoc As String, ByVal SnEntry As String, ByVal SnType As
String, ByVal SerialNo As String) As String
Dim Result
Result = KillDevice(“c:\movemoney\auth”, “mmcm”, “0”, “”, “D”, “R”,2, “5717M”)
ValidateUser
------------
Private Declare Function ValidateUser Lib “SmarteAuth.dll” _{—}
(ByVal DataFile As String, ByVal Pwd As String, ByVal DevCode As String, ByVal
DeviceDetails As String, ByVal SnEntry As String, ByVal DevLoc As String, ByVal SnType As
String, ByVal SerialNo As String, ByVal UserId As String) As String
Dim Result
Result = ValidateUser(“c:\movemoney\auth”, “mmcm”, “0”, “”, “R”, “D”, 2, “5717M”,
“movemoney”)
UserExists
----------
Private Declare Function UserExists Lib “SmarteAuth.dll” _{—}
(ByVal DataFile As String, ByVal Pwd As String, ByVal UserId As String) As String
Dim Result
Result = UserExists(“c:\movemoney\auth”, “mmcm”, “movemoney”)
UserDevices
-----------
Private Declare Function UserDevices Lib “SmarteAuth.dll” _{—}
(ByVal DataFile As String, ByVal Pwd As String, ByVal UserId As String, ByRef
OutNoOfDevs As Long, ByVal OutDevices As String) As String
Dim Result
Dim NoDevices as integer
Dim Devices as string
Result = UserDevices(“c:\movemoney\auth”, “mmcm”, “movemoney”, NoDevices, Devices)
UserIdFromDevice
----------------
Private Declare Function UserIdFromDevice Lib “SmarteAuth.dll” _{—}
(ByVal DataFile As String, ByVal Pwd As String, ByVal DevCode As String, ByVal
DeviceDetails As String, ByVal SnEntry As String, ByVal DevLoc As String, ByVal SnType As
String, ByVal SerialNo As String, ByVal OutUserId As String) As String
Dim Result
Dim ResultUserId
Result = UserIdFromDevice(“c:\movemoney\auth”, “mmcm”, “0”, “”, “R”, “D”, 2,“5717M”,
ResultUserId)
IDDevice
--------
Private Declare Function IDDevice Lib “SmarteAuth.dll” _{—}
(ByVal DataFile As String, ByVal Pwd As String, ByVal DevCode As String, ByVal
DeviceDetails As String, ByVal SnEntry As String, ByVal DevLoc As String, ByVal SnType As
String, ByVal SerialNo As String, ByVal OutUserId As String, ByVal OutContentSN As String,
ByVal OutKnownSN As String) As String
Dim Result
Dim ResultUserId
Dim ResultContentSN
Dim ResultKnownSN
Result = IDDevice(“c:\movemoney\auth”, “mmcm”, “0”, “”, “R”, “?”, 2, “5717M”, ResultUserId,
ResultContentSN, ResultKnownSN)
IDF456999
---------
Private Declare Function IDF456999 Lib “SmarteAuth.dll” (ByVal DataFile As String, ByVal
Pwd As String) As String
Dim Result
Result = IDF456999(“c:\movemoney\auth”, “mmcm”)
LockDataFile
------------
Private Declare Function LockDataFile Lib “SmarteAuth.dll” _{—}
(ByVal DataFile As String, ByVal Pwd As String) As String
Dim Result
Result = LockDataFile(“c:\movemoney\auth”, “mmcm”)
UnLockDataFile
--------------
Private Declare Function UnLockDataFile Lib “SmarteAuth.dll” _{—}
(ByVal DataFile As String, ByVal Pwd As String) As String
Dim Result
Result = UnLockDataFile(“c:\movemoney\auth”, “mmcm”)
ChangeLockPassword
------------------
Private Declare Function ChangeLockPassword Lib “SmarteAuth.dll” _{—}
(ByVal DataFile As String, ByVal Pwd As String, ByVal NewPwd As String) As String
Dim Result
Result = ChangeLockPassword(“c:\movemoney\auth”, “mmcm”, “move”)
GetDeviceSN
-----------
Private Declare Function GetDeviceSN Lib “SmarteAuth.dll” _{—}
(ByVal DevCode As String, ByVal DevLoc As String, ByVal DeviceDetails As String, ByVal
OutDeviceSN As String) As String
Dim Result
Result = GetDeviceSN(“0”, “?”, “”, ResultContentSN)
KillExistingUser
----------------
Private Declare Function KillExistingUser Lib “c:\windows\system\SmarteAuth.dll”_{—}
(ByVal DataFile As String, ByVal Pwd As String, ByVal UserId As String) As String
dim Result
Result = KillExistingUser(“c:\movemoney\auth”, “mmcm”, “move”)
-----------------------------------
Visual C ++ Syntax with Examples for Functions
-----------------------------------
IDF456999( )
---------------
#include <windows.h>
#include <stdio.h>
typedef char* (CALLBACK* LPFN)(char*,char *);
int _{——}stdcall WinMain(HINSTANCE hi, HINSTANCE hp,LPSTR lpcmd, int show)
{
  HINSTANCE hDLL;  // Handle to DLL
  LPFN lpfn1;  // Function pointer
  hDLL = LoadLibrary(“SmarteAuth.dll”);
  lpfn1 = (LPFN) GetProcAddress ( hDLL, “IDF456999” );
  res = lpfn1 (“C:\\MoveMoney\\auth”,“mmcm”);
  MessageBox(NULL,res,“res”,MB_OK);
  FreeLibrary(hDLL);
  return 0;
}
Note:
1) This is the full program for calling routine of IDF456999( ) function of MoveMoney
Enterprise DLLfrom Win32 console application from Microsoft Visual Studio, Visual C++.
2) If the Programmer wants to pass Null to the Password parameter, then declare a variable like
this:
  char *Pwd=“\0”;
and the calling part will be like:
  res = lpfn1 (“C:\\MoveMoney\\auth”,Pwd);
3) For the rest of the functions, only the Calling Routines are given below, not the whole
program like the above example
ValidateDevice( )
---------------------
typedef char* (CALLBACK* LPFN)(char*,char *,char *);
...
lpfn1 = (LPFN) GetProcAddress ( hDLL, “ValidateDevice” );
res = lpfn1 (“0”,“?”,“”);
...
ValidateSNDevice( )
-------------------------
typedef char* (CALLBACK* LPFN)(char*,char *,char *,char *,char *,char *,char *);
...
lpfn1 = (LPFN) GetProcAddress ( hDLL, “ValidateSNDevice” );
res = lpfn1 (“C:\\MoveMoney\\auth”,“mmcm”,“0”,“ ”,“?”,“2”,“5828M”) ;
AddNewUsr( )
-----------------
typedef char* (CALLBACK* LPFN)(char*,char *,char *);
...
lpfn1 = (LPFN) GetProcAddress ( hDLL, “AddNewUsr” );
res = lpfn1 (“C:\\MoveMoney\\auth“,“mmcm”, “adminauth”) ;
...
KillExistingUser( )
----------------------
typedef char* (CALLBACK* LPFN)(char*,char *,char *);
...
lpfn1 = (LPFN) GetProcAddress ( hDLL, “KillExistingUser” );
res = lpfn1 (“C:\\MoveMoney\\auth”,“mmcm”,“adminauth”) ;
...
AssignDevice( )
--------------------
typedef char* (CALLBACK* LPFN)(char*,char *,char *,char *,char *,char *,char *,char *,char
*);
...
lpfn1 = (LPFN) GetProcAddress ( hDLL, “AssignDevice” );
res = lpfn1 (“C:\\MoveMoney\\auth”,“mmcm”,“0”,“ ”,“D”,“?”,“2”,“5828M”,“adminauth”) ;
...
UnAssignDevice( )
-----------------------
typedef char* (CALLBACK* LPFN)(char*,char *,char *,char *,char *,char *,char *,char *);
...
lpfn1 = (LPFN) GetProcAddress ( hDLL, “UnAssignDevice” );
res = lpfn1 (“C:\\MoveMoney\\auth”,“mmcm”,“0”,“ ”,“D”,“?”,“2”,“5828M”) ;
...
KillDevice( )
---------------
typedef char* (CALLBACK* LPFN)(char*,char *,char *,char *,char *,char *,char *,char *);
...
lpfn1 = (LPFN) GetProcAddress ( hDLL, “KillDevice” );
res = lpfn1 (“C:\\MoveMoney\\auth”, “mmcm”,“0”,“ ”,“D”,“?”,“2”,“5828M”) ;
...
ValidateUser( )
------------------
typedef char* (CALLBACK* LPFN)(char*,char *,char *,char *,char *,char *,char *,char *,char
*);
...
lpfn1 = (LPFN) GetProcAddress ( hDLL, “ValidateUser” );
res = lpfn1 (“C:\\MoveMoney\\auth”,“mmcm”,“0”,“ ”,“D”,“?”,“2”,“5828M”,“adminauth”) ;
...
UserExists( )
----------------
typedef char* (CALLBACK* LPFN)(char*,char *,char *);
...
lpfn1 = (LPFN) GetProcAddress ( hDLL, “UserExists” );
res = lpfn1 (“C:\\MoveMoney\\auth”,“mmcm”,“adminauth”) ;
...
UserDevices( )
-------------------
typedef char* (CALLBACK* LPFN)(char*,char *,char *,long *,char *);
...
unsigned char *outDev;long* outNDev;
...
outDev =(unsigned char*)malloc(300*sizeof(unsigned char));
outNDev =(long *) malloc(sizeof(long));
lpfn1 = (LPFN) GetProcAddress ( hDLL, “UserDevices” );
res = lpfn1 (“C:\\MoveMoney\\auth”,“mmcm”,“adminauth”,outNDev,outDev);
MessageBox(NULL,res,“TEST”,MB_OK);
sprintf(outDev, “%s —No of Devices->%d”,outDev,*outNDev) ;
MessageBox(NULL,outDev,“ouptut device sn”,MB_OK);
UserIDFromDevice( )
---------------------------
typedef char* (CALLBACK* LPFN)(char*,char *,char *,char *,char *,char *,char *,char *,char
*);
...
unsigned char *outUser;
...
outUser =(unsigned char*)malloc(300*sizeof(unsigned char));
lpfn1 = (LPFN) GetProcAddress ( hDLL, “UserDevices” );
res = lpfn1 (“C:\\MoveMoney\\auth”,“mmcm”,“0”,“ ”,“D”,“?”,“2”,“5828M”,outUser) ;
//Now, outUser will have the User ID returned from the function
...
IDDevice( )
-------------
typedef char* (CALLBACK* LPFN)(char*,char *,char *,char *,char *,char *,char *,char *,char
*);
...
unsigned char *outUser;unsigned char *outContentSN; unsigned char *outKnownSN;
...
outUser =(unsigned char*)malloc(300*sizeof(unsigned char));
outContentSN =(unsigned char*)malloc(300*sizeof(unsigned char));
outKnownSN =(unsigned char*)malloc(300*sizeof(unsigned char));
lpfn1 = (LPFN) GetProcAddress ( hDLL, “UserDevices” );
res = lpfn1 (“C:\\MoveMoney\\auth”,“mmcm”,“0”,“
”,“D”,“?”,“2”,“5828M”,outUser,outContentSN,outKnownSN) ;
//Now, outUser will have the User ID returned from the function
//Now, outContentSN will have all the Content Serial Nos returned from the function
//Now, outKnownSN will have the Known Serial Nos returned from the function
...
LockDataFile( )
------------------
typedef char* (CALLBACK* LPFN)(char*,char *);
...
lpfn1 = (LPFN) GetProcAddress ( hDLL, “LockDatafile” );
res = lpfn1 (“C:\\MoveMoney\\auth”,“mmcm”);
...
UnLockDataFile( )
------------------
typedef char* (CALLBACK* LPFN)(char*,char *);
...
lpfn1 = (LPFN) GetProcAddress ( hDLL, “UnLockDataFile” );
res = lpfn1 (“C:\\MoveMoney\\auth”,“mmcm”) ;
...
ChangeLockPassword( )
------------------
typedef char* (CALLBACK* LPFN)(char*,char *,char *);
...
lpfn1 = (LPFN) GetProcAddress ( hDLL, “LockDataFile” );
res = lpfn1 (“C:\\MoveMoney\\auth”,“mmcm”,“newauth”);
...
GetDeviceSN( )
-------------------
typedef char* (CALLBACK* LPFN)(char*,char *,char *,char *);
...
unsigned char * outSN;
outSN=(unsigned char *) malloc(20*sizeof(unsigned char));
lpfn1 = (LPFN) GetProcAddress ( hDLL, “GetDeviceSN” );
res = lpfn1 (“0”,“?”,“ ”,outSN) ;
...
```

The Smarte CD™

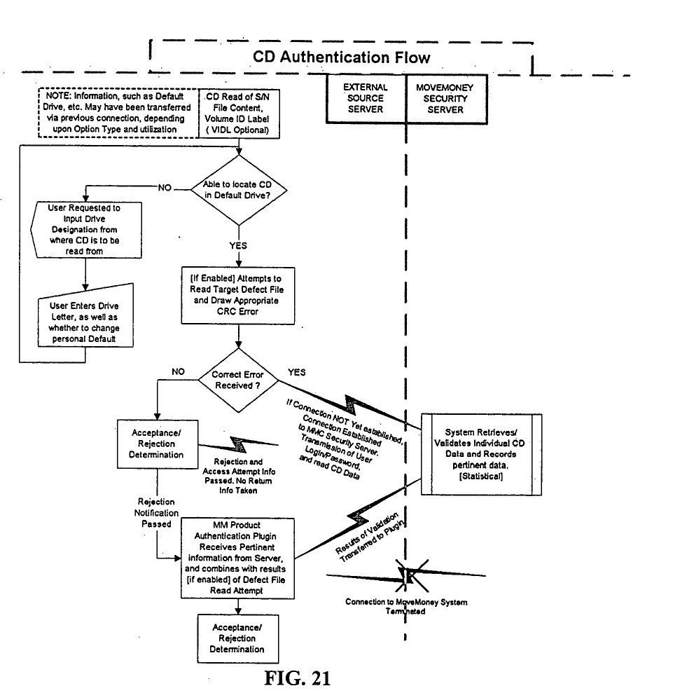

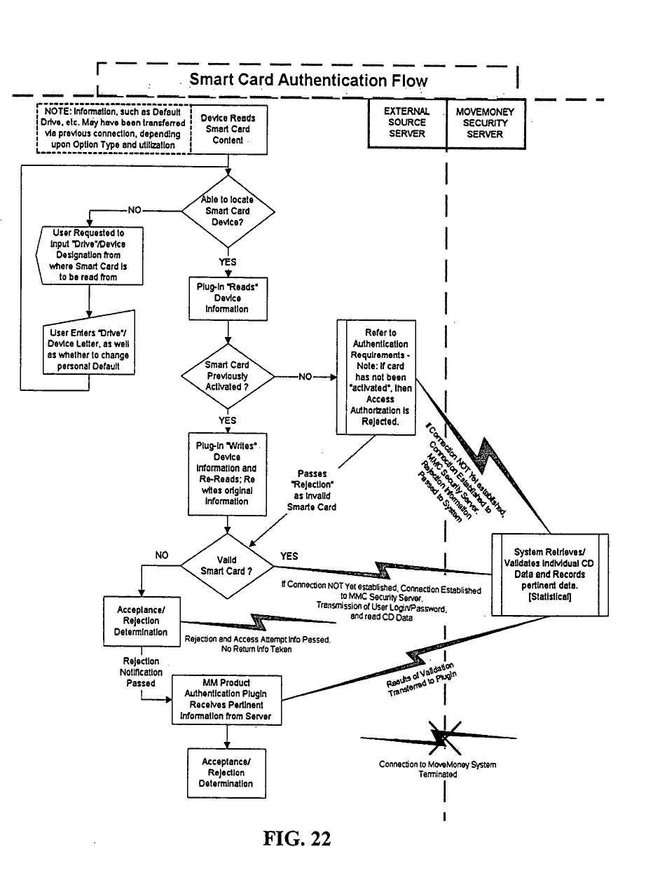

The Smarte CD™ may have any or all of the validation and serialization methodologies applicable, depending on the CD usage. For example, for User Access Authentication, ALL of the methodologies may be employed, however, for Product Validation, only some of these methodologies may be chosen to be used by the supplier of the software. The validation process for the Smarte CD™ is displayed in FIG. 21.

Like the Smarte CD™, there is a specific validation flow for the Smart Card, as shown in FIG. 22. Unlike the Smarte CD™, however, the Smart Card is used solely for User Authentication, and therefore the validation process and methodology for the Smart Card is fixed.

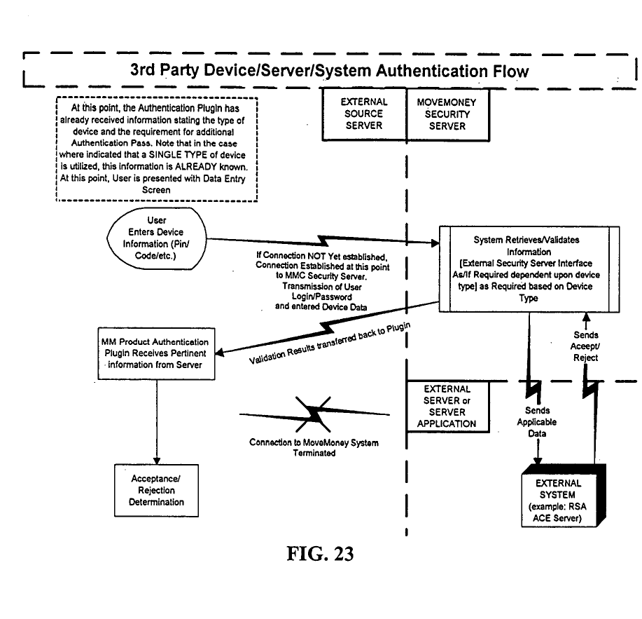

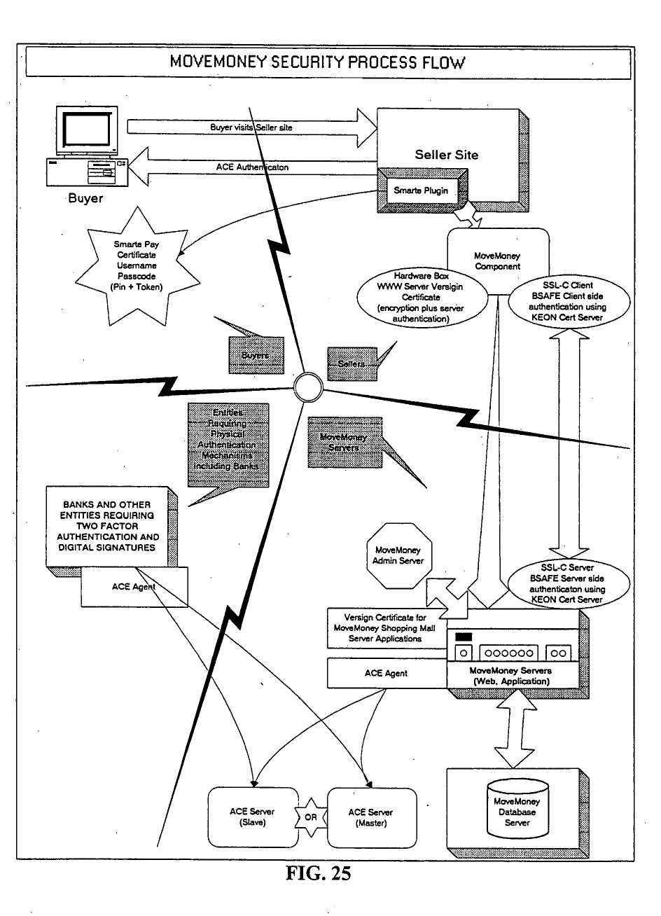

The specific validation flow for Third Party Devices is as shown in FIG. 23. In this case, it is the Smarte Authentication™ portion of the Smarte System™ that interacts with the external authentication server or software. In FIG. 23, this validation flow is displayed. In FIG. 23, the external authentication mechanism is displayed as a separate physical server, however it could easily just as well be a program running in the background on servers. This flow is valid regardless of physical proximity or location to the servers, the requirement only being a clear and secure communications channel to exchange information. FIG. 25 uses the RSA™ ACE™ Server as an example, to display a “typical” set-up, include recommended “hardware” involved. Note that this structure is defined on the system itself maintaining the ACE™ server, and allows for users to utilize RSA™ devices without having to register within the Smarte Authentication™ system, going DIRECTLY to the ACE™ Server.

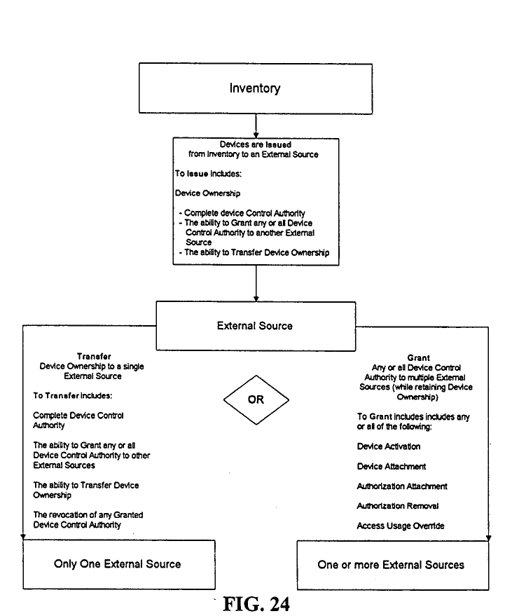

The basic flow for the Authentication Process is represented in FIG. 24. The system receives purchased devices/device media, and adds to inventory as required dependant upon the type of device. Depending on the device type, one of the following will apply as applicable:
The system Generates Serialized CD's From Inventory
   Import Listing of Serial Numbers, SN Strings, Volume Labels, etc.
   Option to ADD as individual items or apply against existing inventory
The system Generates Serialized Smart Cards from Inventory
   Import Listing of Serial Numbers, SN Strings, Volume Labels, etc.
   Option to ADD as individual items or apply against existing inventory
The system may include 3^{rd} party devices as required

Following the devices being placed in inventory, the system issues the devices to the External Authentication Sources for Distribution to End Users and/or Internal Use. The present invention, utilizing the Authentication Issue Screens issues the devices to the applicable External Source either by Lot, Device Serial Number Range, or SINGLE device. This results in “ownership” transfer to the applicable External Source. The External Source retains ownership even after assigning a device to an End User, as it is the External Source who retains control over the device and the options for that device. As the Device Ownership is conferred, so to is Complete Device Control Authority for each of the devices Issued.

From this point, the External Source receives the devices from the present invention. It is up to the External Source how it wants to physically distribute devices to its end users—through mail, in person, or by 3^{rd} Party, for instance.

The External Source will Attach Access Authorizations to each device. This can be done individually or in a “bulk” group (many selected Authorization Masters against many individual devices) as needed.

Once the devices have been distributed to the End Users, the External Source “Activates” the particular device manually in system, entering any applicable back-up information as required based on the activation.

Another mechanism for activation of a device that can occur is where the End User “Remotely” activates the device, based on additional information sent to them, personal information previously known to the External Source, or a combination of this. In this case, the End User performs this activation of the device via entry into a “special” area of the Smarte System™. The basic flow requirements for this are as follows:
End User “Activates” Device Automatically
   End User receives and physically has the device in their possession.
   End User is provided a URL to go to for automatic device activation.
End User goes to the URL provided [EUAS01, EUAS02] and is prompted for device specific information (serial number printed on the device).
End User enters the device specific information
IF the device is found, THEN the End User is prompted for their identifier information.
End User enters their personal identifier.
   If personal identifier is a correct match, THEN the system activates the device. The End User is given confirmation that the device has been activated.
   ELSE the End User is re-prompted for their personal identifier.
      [This occurs three (3) times at the most.]
   ELSE the End User is given a message that their device is not activated and to contact customer service.

Still another mechanism for activation is where a 3rd Party “Activates” Device Manually. This can be done where the External Source has no desire, infrastructure, and/or resources to perform the activation. The system allows the “owner” of a device to extend specific authority for actions and control to other External Sources. Note that also extends to the assignment of devices to End Users as well. The basic process is as follows:
End User receives and physically has the device in their possession.
End User was provided contact information with the device regarding 3^{rd} party Activation of the Device.
End User contacts the 3^{rd} Party/3rd party Contacts End User
3^{rd} Party User Logs into the Smarte Authentication™ system.
3^{rd} Party User goes to the End User Activation screen.
3^{rd} Party User retrieves the device number (printed on the device) from the End User.
3^{rd} Party User enters the device number.
IF device is found, THEN 3^{rd} Party User retrieves the personal identifier information from the End User.
3^{rd} Party User enters the personal identifier information.
IF the personal identifier matches, THEN the device is activated.
   3^{rd} Party User is given confirmation that the device is activated.
   3^{rd} Party User notifies the End User that the device is activated.
ELSE, the identifier does not match,
   3^{rd} Party User is given screen notification that the identifier does not match.
   3^{rd} Party User notifies the End User that the personal identifier was incorrect.
ELSE, device is not found,
   3^{rd} Party User is given screen notification that the device is not found.
   3^{rd} Party User notifies the End User that the device number is not valid.

There is an additional option during Device Assignment to an End User, whereby the Device can also be activated at the same time as Assignment by the system. This is used primarily where direct physical contact and physical identification of the End User occurs.

For an External Source to Transfer Device Ownership, it must first hold Device Ownership.

Device Ownership can be transferred either in groups by Lot or Serial Number Range. The External Source User chooses the method by which Device Ownership is to be transferred. Based on this choice, the External Source User goes to the Transfer Lot screen or Device S/N Range Transfer screen. Here, the device(s) to be transferred are selected (by Lot or Serial Number Range). The system prompts the External Source User for the External Source ID to which Device Ownership is to be transferred. The system checks that the External Source from which Device Ownership is to be transferred does, indeed, hold Device Ownership for the selected device(s). For any breaks in the master series (breaks defined as Device Ownership not held by the External Source), the system generates new Lot designations for unbroken sub-series existing within the master series. The system then Transfers Device Ownership to the new External Source by any new Lot designations created.

The system must remove all Device Control Authority for all Device Ownerships Transferred from the original External Source. Since Device Control Authority is validated at the External Source Level, there is no direct affect in any data tables concerning this. Once ownership the ownership transfer is completed, any Device Control Authority granted to other External Sources by the External Source having ownership of the devices is automatically applied. Upon completion of Transfer, all Device Control Authority now rests solely with the destination External Source.

Any External Source that holds Device Ownership retains Complete Device Control Authority, regardless of whether any or all Device Control Authority is granted to another External Source.

Granting of any Device Control Authority can only occur from the holder of Device Ownership to another External Source, i.e. the External Source receiving the Grant of Device Control Authority cannot further delegate that authority to another External Source. The External Source holding Device Ownership can, however, Grant the same type of Device Control Authority to multiple External Sources. To Grant Device Control Authority, the system must know the Devices for which Control Authority is being Granted (by Lot or System Serial Number), the ID of the External Source to which the Device Control Authority is being Granted, the ID of the holder of Device Ownership, and the specific types of Device Control Authority being Granted. The system should check that the External Source that is granting the Control Authority is, indeed, the holder of Device Ownership for the selected devices. To Grant, the system must extend those chosen management rights for the selected devices to the designated External Source.

Individual Devices are assigned to an individual End Users using one of the following methods:
Via Plugin Specified as Single Device/Device Type Only (Fixed Source). Login is routed via Smarte Authentication™ Plug-in. Plug-in acts simply as portal for information to pass. All validations of acceptance/rejection performed on the Security Server.
Via Plugin Specified as Multiple Devices/Device Types (Fixed Source). Login is routed via Smarte Authentication™ Plug-in. Plug-in acts simply as portal for information to pass. All validations of acceptance/rejection performed on the present invention's Security Server.
Via Plugin (Smarte System™ Login). Login is routed via Smarte Authentication™ Plugin OR Plugin “simulated” code as part of Smarte System™ itself. Plug-in acts simply as portal for information to pass. All validations of acceptance/rejection performed on the present invention's Security Server.
   System Security, Policies, and Programming Guidelines

The Corporate Security Policy is a high-level document that states senior management's directives for the corporation's overall security.

Digital certificates and Tokens are used for user authentication. Digital certificates and secret key encryption are used for process authentication.
Authentication, authorization, access control framework products provides more security than basic operating system capabilities.
Security policies ensures that the system defines overall security responsibilities and defines consistent guidelines for performing security-relevant functions.
Encryption provides both data confidentiality and data integrity.
The system will not be able to control the Seller's web site that the Smarte VII™ platform will be installed in. Thus, some of the components operate in a “hostile” environment. The system applies least privilege concepts to restrict the capabilities of these components, as well as limit the sensitive information these components can access. The corporate security policy covers these areas:

Issue statement: The policy's goal, the definition of the issue. The primary goals are to maintain high integrity, to prevent fraud and to prevent unauthorized disclosure.

Position statement: Management's decision on how the issue is approached.

Applicability: Where, when, how, to whom, and to what the policy applies. Applicability specifies the facilities, hardware, software, information, and personnel that the policy covers. Roles and responsibilities: The management and technical roles to implement the policy and to insure the policy's continuity. This also outlines the organizational responsibility for operational security and defines employee accountability.

Compliance: The policy's definition of how violations are handled and disciplinary actions, such as penalties. Monitoring responsibilities are covered in the responsibilities statement.

Legal requirements. The legal requirements for e-commerce services are different in different jurisdictions. Growing concerns over Internet privacy are spurring new legislation and guidelines in this area.

The system supplements the overall corporate policy with detailed operational policies. These provide specific security rules for particular systems, such as the rules and practices that regulate how a system manages, protects, and distributes sensitive information. Examples of operational policies include policies for physical security, platform hardening, disaster recovery, and Internet usage.

The following Basic Programming and Security Implementation Guidelines will be adopted in the implementation of the Smarte™ system. The guidelines address the most common web pitfalls that may leave web applications open to intruder attacks.

Physical Security and Security Awareness are of extremely high importance. Intruders who can gain physical access to systems can plant tools that they can use to gain remote access to the system later, even through firewalls. Other intruders may do physical damage to systems.

Physical security concerns how access to development and production systems is restricted. Another physical security concern is access to non-production systems that have connectivity to production systems. The system will address the following issues in this area: the system will enforce physical access restrictions to the production systems. Servers that contain sensitive information, such as financial account data, will have additional protection. Security awareness training, including common social engineering techniques, are provided to highlight the common techniques intruders use to gain physical access. It will also make employees cognizant of the need to protect corporate intellectual property from exposure in public conversations and in email.

In the hostile Internet environment, all applications are built defensively to be able to withstand intruder attacks. In particular, applications will not trust any input from external sources, including web form entries, hidden field values, applet inputs, or any other data received from an external source.

Nothing received from the user, including form elements and hidden fields, are considered trusted. “Bad” characters such as shell escapes and control characters in all user input are filtered. Tainted-Perl concept (any data that comes from an unsecured source is tainted until it's explicitly cleansed of potentially harmful content) to user inputs is applied.

Buffer overflows are kept at a watch; Size restrictions to all user inputs are applied.

All incorrect data types (characters in numeric fields, invalid dates, out of range data) in all entries are kept at a watch.

Session ID's are kept long, e.g. 30 characters or more; be random and not repeat over time; not contain any user information, but are tied server-side to a specific user ID; expire within a reasonable time period (e.g., minutes, not days); and be sent over a secure path. The system tracks the user's IP address to avoid IP hopping (changing the session IP address during a session), a probable indicator of session hijacking. In addition, the same User ID will not have multiple sessions at any given point of time.

Temporary files are avoided, and are automatically deleted as they can provide sensitive information to others if file system permissions permit access or if the system is hacked. Moreover temporary files occupy disk space and hence are automatically deleted from the system. Writing of temporary files to publicly accessible directories, such as /tmp are avoided.

User sign-off functions actually sign off a user. Session data are not cached on the user's system. Log out pages are not cached to prevent another user to use the browser back key to view session data. Session timeouts are auto programmed. Users are instructed to close their browser if cookies or other session information may persist. This is done by “in your face” mechanism such as a browser pop up.

Strong ciphers are used to protect information. Web servers are set to require specific ciphers, not negotiate a common cipher set. Otherwise, user could set their browser use no ciphers or message authentication codes, leaving the connection vulnerable to eavesdropping. Key length may have an impact on application performance. Applications are tested with different key lengths to understand the application impact.

Pages that contain sensitive information for caching are checked. HTTP Headers “no-cache” and “expires” are used to prevent caching.

Anything downloaded to the user could be dissected, altered, and attacked, and therefore the following are recognized and addressed by the system in the design and function: User-friendly variable names are vulnerable to guessing and spoofing; Hidden fields can be edited; Applets can be reverse engineered; Anything in the browser page cache directory are examined; Cookies are analyzed; Minimum amount of data on the user system are cached.

Partial session attacks are avoided. Session resources are not allocated until after the user has successfully authenticated. Otherwise, partial authentication attempts floods could exhaust server resources. Explicit session connection timeouts are set.

Storing sensitive information in clear-text are avoided on externally accessible systems. Sensitive information such as, User Ids and passwords, Encryption Keys, Transaction Data, Credit card numbers, Account numbers, Internal system names and IP addresses and internal user account ID's are especially avoided to be left in clear-text.

Browser-side checks are not reliable. JavaScript, VB Script, or other scripting checks done in the user browser can be easily circumvented. These checks are considered a convenience to the user. All checks are duplicated on the server.

System Hardening. Internet accessible systems are hardened to remove potential vulnerabilities that an intruder could exploit. Services that are not needed to support the application, but that could provide an entrance point into the system would be disabled. Known security holes in operating systems and applications that have not been closed are removed.

Hardened Server Platform. All unnecessary services from the operating system are removed. Extraneous services that may be packaged with the web service (e.g., FTP, file upload, Gopher) are disabled. All unused user ID's are removed. Password rules, especially for administrator accounts are enforced. Strong authentication for administrator accounts, especially for externally accessible systems are applied. Contents in the web server's environment are made known and PATH settings are kept as minimal as possible and absolute paths are maintained. Security patches are kept up to date; system settings are rechecked after patching. Web server admin functions are shut down when not in use. Admin functions that are HTML-based, are not externally accessible.

The supporting services that underlie application services are also hardened, and therefore operate securely as otherwise they could be used to provide information for attacks, or as attack launching points. These services are also hardened against Internet intruders. The service provider maintains awareness of current Internet attacks and provides basic services such as IP address spoofing filtering and attack monitoring. (IP address spoofing is where a hacker discovers an IP address assigned to an internal host and uses it in traffic that they send from the Internet.) The service provider service contract defines their responsibilities for alerting the system if the provider detects an abnormally large amount of traffic going to the system site.

The system will review its service agreement to ensure that it contains provisions for basic security services. The agreement will clearly state the service provider's responsibility and time windows for notifying the system of suspicious Internet activity.

IP-based access restrictions. IP address restrictions is used in conjunction with a DNS reverse lookup. This check verifies that the IP address is registered in a valid DNS map, and that the DNS map has matching entries for IP-hostname and hostname-IP. This helps prevent IP spoofing attacks. The following restricts the IP addresses that can connect to a particular service: Service user ID and file system permissions: If the web server is broken into, the intruder will most likely gain access to the user ID that the web service runs as, either by gaining access to a shell or by tricking the application into running arbitrary commands. The user ID has as few privileges as possible. For example, the user ID will not be able to replace any of the application class files or executables. File system permissions applied to web page and other application files, such as servlets, JSPs, ASP, and CGI executables are also checked.

Directly accessible content on all systems involved in the application, especially externally accessible systems are outlined. Directly accessible ports on every system are outlined. Directories indexed for search are outlined. Directories containing restricted files or sensitive information are not indexed. Directories are not browsable, especially directories containing sensitive information, configuration files, or application executables. Security configuration recommendations for customers to warn them about potential risks are developed. The following are a part of the system: User browser option settings, such as disabling caching encrypted pages to disk; file system permissions settings for unmasks and application file system permissions; platform hardening; required Service account privileges; and environment settings needed for the application.

The present invention's production systems is tightly controlled, both for security and stability via a Secure Administration. The system administers its production systems itself. Since the production systems is housed at a remote facility, the system uses a secured communications line to provide a secure communications path from its development office and the production site. Secure administration approach includes:

Monitoring: Event notices transmitted over un-secure media can be viewed, altered, or lost. Event notices can potentially give outsiders information on the type and configuration of the internal system components.

Remote administration is done with extreme care and limited to only a small specific group of individual user computers, as otherwise it can introduce security holes by transmitting privileged user authentication information over a network where it may be monitored and recorded. In addition, privileged commands may also be transmitted in the clear, where they can be recorded and replayed. Administrators have not left any backdoors in remote systems to facilitate remote access.

Security criteria is included in the administration tool selection criteria. Features that strengthen the tool's security include support for strong authentication and replay attack prevention features.

Security principles define the fundamental security concepts for the system. The system has these principles:
Resource privileges to subjects. These privileges are the ability to create, modify, and delete resource instances, and to read and write resource attribute values.
Subjects have full privileges to the resources they create.
   Example: a financial institution user creates a buyer account. The financial institution user can view and change the buyer's account information, or can delete the account.
Subjects can authorize other subjects to have access to the subject's resources.
   Example: the financial institution can grant a buyer ‘read access’ to all of their (the buyer's) information. The financial institution can grant a buyer the ability to create specific new information within their (the buyer's) account, such as address book entries, and to modify other data, such as the default shipping method. The financial institution retains the right to view any of the buyer's data, such as for customer service.
Subjects can create subordinate subjects.
   Example—buyers may create sub-buyers who may access the buyer's account.
Subjects can control the authorizations of their subordinate subjects.
   Example—a buyer may authorize a sub-buyer to only be able to view transaction histories. The sub-buyer cannot create new transactions.

The main Application Security Components for the distributed applications are as follows:
Authentication component assure a subject's identity, that is, the subject is in fact who it claims to be.
Authorization and access control component assign privileges to subjects and control subjects' access to resources based on those privileges.
Accountability component uniquely traces a subject's actions to it.
Data integrity component assures data is not altered without authorization.
Confidentiality component assures data is not disclosed without authorization.

The system requires subjects to pass Authentication at system entry points, i.e., the external service perimeters and internal system boundaries. At each point, the system requires one-way or mutual authentication. External entry points are accessible from the Internet. The entry points are:
Web server: End users authenticate before they will be allowed to manage their profile via the web application.
Payment server:
   Buyers are authenticated before they will be allowed to access their account for payment. This authentication is passed through the seller's web application to the payment server via the Smarte VII™ platform.
   Seller systems authenticate to the payment system before they can submit transactions.

Internal service points will be accessible to internal systems and users. The entry points are:
Admin server: Administrators are authenticated before they are allowed access to administrative applications.
Application server: Depending on the security of the internal LAN, direct access to the application server requires authentication.
Remote access: The remote access server acts as a gateway between a remote location and the systems at the service provider facility so that employees can administer the operational systems. The remote access device may be a separate device, may be integrated with the service provider firewall, or may not be used if the communications link is a private leased line.
Database server: The database server requires authentication to access the database.

The system uses two main categories of authentication: User (human) authentication and Process authentication for inter-process interactions. User authentication prompts the user to enter authentication information. With process authentication, the process invokes the authentication mechanism automatically. Since the Smarte™ suite of offerings deals with payment and financial institution accounts, the system uses very strong authentication mechanisms. Most credit card services do not use strong authentication, so this provides the system increased security over most credit card services.

Challenge/response: The system produces an unpredictable challenge that varies with time. The subject generates a response, using secret information known only to that subject. The system adopts the challenge/response based on digital signatures and public key certificates. With this type of challenge/response system, the subject is given some data that it must digitally sign to prove its identity. The recipient of the signed challenge verify the signature with the subject's public key. Digital signatures are based on RSA algorithms, the most prevalent in the industry today. The subject being authenticated has public key/private key pair and public key certificate. For others to accept the subject's public key certificate as genuine, the certificate is issued by a trusted third-party. The subject's private key is protected, as it constitutes the actual proof of the subject's identity. Secure Sockets Layer (SSL) uses this form of challenge/response authentication. Smart cards or Custom CDs are used to store the private key and certificate. The card or CD can perform the cryptographic functions so that the private key is never exposed. Smart cards require the subject to have a smart card reader and Custom CDs require the subject to have a CD ROM drive. Key pairs can be generated by browsers and stored in the browser's key database, but this renders them susceptible to theft. Key pairs for special use uses RSA's BSAFE Crypto-C cryptographic libraries. Certificate generation is done with RSA's KEON Certificate Server using the RSA's BSAFE Crypto-C cryptographic libraries.

Token: A token is something that a subject possesses that they present as part of their authentication. The system will use RSA SecurID for the Token authentication. This is a physical or software device that displays a time-varying multi-digit number (the number changes once a minute). To authenticate, the subject must present their user ID, the current number, plus the PIN they get assigned when they signup.

Another important facet of an authentication component in the system is how failed authentication is handled. The failure handling will not reveal any additional information about the subject or why the authentication failed (e.g., an error message will state “authentication failed” not “invalid password” or “invalid user ID”). Limiting the number of authentication retries prevents guessing attacks. Repeated login failures generates a security event to detect systematic attacks. The system logs these events. The system also supports sending notices to the owner of the account experiencing the failed logins. Authentication state tracking is an important part of session management for web applications. The web application distinguishes each authentication phase so that subjects cannot bypass authentication.

Authorization consists of granting one or more privileges to a subject. The system's Authorization mechanisms assigns privileges at different granularities. For financial systems, granular privilege assignments are required. Since financial account data is highly sensitive, the system assigns permissions for viewing, modifying, and deleting to specific resources. Furthermore, the authorization system supports the ability for subjects to allocate some or all of their privileges to other subjects, but constrains the allocation so that subjects cannot give away privileges they do not have.

In the system, authorization takes place as follows:
When a new user account is created or modified. The creating subject assigns privileges to the new subject so that the new subject can access its profile and its funds.
By explicit action of superior account. For example, a user can explicitly grant privileges to a sub-user.
By delegation: In delegation, a subject authorizes another subject to act on its behalf, with some or all the original subject's privileges. For example, a process will assume a user's identity and perform actions on the user's behalf.

The authorization database and authorization assignment functions will be secure or subjects will be able to adjust authorization assignments themselves.

Access Control mechanisms enforce the permissions a subject must have to access resources. Access control can be controlled with widely differing granularity, ranging from no access controls to controls on individual resources within applications, such as fields within database records. As with authorization mechanisms, the system requires access controls with the ability to support a wide range of granularity, in particular, it enforces that subject's have the required permissions before granting access to sensitive resources. Access controls thus applies to all subject types, human and machine. The system employs the following access controls:
Operating systems: Intrinsic permission enforcement controls that are built into the operating system. The operating system enforces owner/group/public permissions for read/write/execute.
Policy objects: An object-oriented approach to access control, where a policy object defines the attributes needed to access a resource. Subjects are assigned privilege attributes; the policy object maps authorization privileges to access rights.
Container-based: A container provides an execution environment for entities that reside within in it. Part of this environment is access control based on the container's security policy.
Access control lists: A permission list associated with a resource that defines the privileges a subject must possess in order to gain access to the resource and the type of access the subject is permitted.
Rules: Rules define a set of characteristics or conditions that must be met before access is granted.
Labels: Mandatory access control is based on sensitivity labels assigned to resources. Subjects must be cleared to access the sensitivity level defined in the label before being allowed access to the resource.
Capability-based: A capability identifies an object and a set of access rights to that object. Any subject that holds the capability can use it to perform the operations permitted by those rights. Capability-based security is efficient because no special checks are needed to verify that a subject has a particular permission; the possession of the capability signifies that permission has been rightfully obtained.

Internal access points occur whenever a subject or process accesses a resource. Access controls are applied whenever a subject requests access to a resource. Caching permissions can improve performance, as can dynamically adjusting the function set made available to a subject so that the subject only “sees” permitted functions. For example, a user's GUI is dynamically constructed so that the user only sees the menu items they are authorized for, reducing the access control checking needed in the GUI. Web applications need to pay particular concern to access controls, since some users will attempt to subvert access controls wherever possible. Issues that are considered include:
Menu bypass. If users can gain information on how menu items are invoked, they may try to bypass the menu system and invoke functions directly. The menu system does provide information on how internal functions are accessed.
Direct invocations of web resources. As an example, Java servlets can be accessed by: directly connecting to their URL. Unless the servlet first applies access controls, this may enable a subject to invoke the servlet's functions without authorization. Implementing access controls in all servlets is highly redundant. Therefore a central servlet dispatcher that performs the access check, then dispatches the correct servlet for the function is implemented for efficiency.
Interprocess communications.
Direct connections to sockets. Any service that listens for connection on a socket will assume that only authorized subjects will connect to it. The application performs an additional access control check, or network access will be restricted.
Named pipe, other IPC methods. Any service listening for connections ensures it does not accept unauthorized connections, or the environment is set up to restrict possible connections.
User session handling. Web applications require some form of user session identification to track and control a user's actions. This session ID is not predictable or guessable. The session ID generator also has a good random number generator. Sessions have a finite lifetime to prevent session theft or hijacking. Session information is sent to the user's browser in three main ways:
   A cookie. This is stored in the browser-specific cookie store. Since the cookie is in a file, the user must find the cookie file to view the cookie. In addition, the cookie itself is a session value, so no hard file is stored, making it more difficult to capture. In addition, the web application expects that users might tamper with cookies. Integrity checks are applied to help detect tampering.
   A hidden field. This information is encoded in HTML tags within the form itself. The user can view the session ID by viewing the page source.
   URL encoding. The session ID is appended to the URL in a particular format. The session ID is visible at all times.

Accountability mechanisms ensure that a subject's actions can be uniquely traced to it. Two accountability mechanisms are applied to the architecture: audit logging and non-repudiation.

Audit logs record a permanent trace of a subject's actions. An audit policy defines the security relevant events that are recorded, for example log on, log off, failed authentication, and other events that affect system configurations or sensitive user application data. The policy also defines what actions to take when audit logs reach their maximum size.

All audit log records are sent to a central audit facility. The audit event notices adhere to a standard format. An event notification protocol transmits the event notice from the emitter to the central collection system. RSA Security Keon Event Logging Server's advanced PKI products and Emails route event-logging information to a centralized Event Logging Server (ELS) against which reports may be run. Monitoring products filter log records for patterns of events that indicate potential security incidents. Some products automatically generate alerts to administrators. Administrators can thus receive one meaningful notice as opposed to many low level events. Secondary event notices are generated as a result of an event or a combination of events. For example, the system logs failed authentication attempts, but also forwards an event notice to the account holder and to administrators in the case of repeat authentication failures. The audit records are archived for a period long enough to support potential investigations. In addition, the records are protected against change in case a dispute or security incident needs to be investigated. Periodic audit reports are generated as a useful management tool since they show usage patterns.

Non-repudiation mechanisms provide proof that a subject participated in an action. The exact nature of the proof required vary according to the laws in the jurisdiction. Proofs that may be required include proof that the sender intended to perform the action (e.g., buy something), proof that the transaction actually came from the sender, proof that the transaction has not been altered since the sender initiated it, proof that the communication between the two parties occurred, and proof that the transaction record has not been altered. Non-repudiation is a complex subject, since the legal requirements for evidence are not the same in all jurisdictions. In the United States, non-repudiation is tied to digital signature legislation. Currently, the States are enacting their own legislation, as is the Federal government. The situation overseas is about the same. Technology to support non-repudiation is still “leading edge”. Few, if any, non-repudiation lawsuits have taken place. When they do, the legal requirements will become clearer. In the near-term, mechanisms that will support non-repudiation in the system include:
Application-level signatures on submitted form data. eXtensible Markup Language (XML) is used as the preferred method of structuring signed forms.
Signature verification. For a digital signature to have meaning, the application establishes that the user's certificate was valid at the time of the action. This verification requires verifying the digital signature on the certificate, checking the certificate's validation period, and checking the certificate against the issuing certificate authority's Certificate Revocation List (CRL).
User intent. Most jurisdictions' rules of evidence require some indication of the user's intent to sign the transaction. This helps to establish that the user is fully aware of the consequences of their signature.
Time-stamps. The application applies a timestamp when the signature is applied. Without this, the application cannot check that the certificate was valid at the time the action took place. The timestamp is “secure”, i.e., unforgeable.
Secure audit trails. Records of the non-repudiation action is stored so that they cannot be changed after the action has occurred.

Digital signatures are a primary means of obtaining non-repudiation. Multiple digital signatures may be needed to achieve non-repudiation sufficient for a legal contest. Non-repudiation can occur at multiple levels in the application:

The endpoints in the communication session, such as an SSL session, exchange a secured data structure, such as a digital signature, that authenticates them. This validates that a session between the sender and receiver took place.

Interactions between middleware services, such as between object request brokers (ORBs), include a secured data structure, such as a digital signature, that validates the service's authenticity. Interactions are securely time-stamped and logged. This validates that an interaction took place.

The transaction is accompanied with a secured data structure, such as a digital signature, that validates its authenticity; the transaction is time-stamped and logged. This validates that a transaction took place.

The end-user's intent to take the action is recorded, the application actions are uniquely and irrefutably traced to the user by the user digitally signing the transaction data, and the action is securely time-stamped and securely logged. This validates that the user's intent to engage in the action and that the action took place.

Data Integrity mechanisms ensure that data has not been altered or destroyed by unauthorized subjects. Data integrity mechanisms are usually based on hash functions that use a one-way immutable function to produce a unique value from the variable length input data. Simple checksums produce a hash using low-overhead algorithms. Encrypted checksums are simple checksums that have been encrypted using a secret key. An encrypted checksum is harder to alter than a simple checksum. The SSL protocol uses an encrypted checksum called a message authentication code (MAC) to detect changes to data while in transit. Digital signatures combine a hash function and asymmetric encryption to construct a secure encrypted hash of a specific set of data. Data integrity mechanisms apply primarily to data. Data integrity are applied to the sensitive user information, including user and transaction data stored in the database.

The main categories of the data integrity mechanisms are as follows:
Encrypted checksums. Encrypted checksums are simple checksums that have been encrypted using a secret key. An encrypted checksum is harder to alter than a simple checksum. A special case of an encrypted checksum is a message authentication code (MAC). Encrypted checksums are encrypted with RSA asymmetric encryption. Encrypted checksums are typically applied to data where change detection is important. Common uses are audit records of financial transactions where they transaction may later be disputed.
Message authentication code (MAC). MACs are one-way hashes produced using secret key encryption. MACs are primarily used in communications sessions to verify the data's origin and that the data exchanged was not altered en route. MACs are used to protect communications against undetected change.
SSL: The SSL session's master secret is hashed into a sequence of secure bytes. Part of the secure bytes are used for a MAC secret. The MAC secret is hashed with the message data, then hashed again with the results of the first operation. The output of the MAC operation is encrypted according to the negotiated session cipher specification.
Digital signatures. Digital signatures combine a digest function and asymmetric encryption to construct a secure digital signature of a specific set of data. Specifically, a digital signature is a digest computed over a specific set of data using a message digest algorithm. The computed digest is then encrypted with a private key. The signature is verified by re-computing the digest with the same algorithm over the same data set. The signature is decrypted with associated public key, and the decrypted digest value is compared with the original digest. If the values match, the signature verifies; otherwise verification fails. Where Digital Signatures themselves are utilized, the RSA algorithm will be applied in the system.

All these data integrity mechanisms are applied as applicable in the system. Simple checksums are used in internal environments for change detection. Encrypted checksums and digital signatures are used for protecting transaction data, especially if the transaction data may be disputed. MACs are used with SSL. Data integrity mechanisms have two main issues: where to apply them and how to manage encryption keys when encryption is used. For end-to-end integrity, data integrity mechanisms are applied at the point the data is created and passed through with the data throughout the data's lifetime. Data integrity mechanisms provide change detection, but also incur both processing and storage overhead. Issues for key management include the following:
Key distribution: Delivering keys to subjects are done electronically through participating Financial Institutions or Exchanges.
Key update: Keys are changed periodically. Updating a key reduces the risk of the key's exposure over time. Key update involves not only key distribution for the new key, but keeping track of when keys are due to expire.
Key revocation: If a key is exposed, it will be invalidated so that it can no longer be used. This can be as simple as refusing to accept the key, if the key is only used in pair-wise connections. Asymmetric keys would be reissued through the certificate authority. The certificate authority will revoke the public key certificate and include the certificate in the certificate revocation lists that it issues.
Key backup: Encryption keys will be stored in a secure backup facility. If the keys are lost, the backup copy of the key can be used to replace the lost key.

Confidentiality mechanisms ensure that information is not disclosed to unauthorized subjects. Confidentiality mechanisms are usually based on encryption, where symmetric key algorithms, asymmetric key algorithms, or both, may be used. As with the data integrity service, the confidentiality services also primarily apply to data. Data confidentiality applies to data in transit and data in storage. The main categories of data integrity mechanisms are as follows:
Symmetric key encryption: All parties authorized for the data will have an access to the decryption key. Symmetric key encryption are applied for pair-wise confidentiality, e.g., only the data owner and the system are authorized for the data. If more subjects are authorized, then group encryption keys are needed.
Public key encryption: For confidentiality, the asymmetric keys are used in the opposite fashion from a digital signature—the subject's public key encrypts the data, then only the holder of the matching private key can decrypt the data. This provides strong individual privacy protection since only the private key holder can access the data.
Proprietary Encryption: In addition to the standard, additional encryption routines may be utilized for data that is not of a “critical” nature, but should still be afforded some measure of protection.
Combinations of Encryption Techniques: Where information is of the utmost critical nature, multiple encryption methodologies may be utilized in conjunction with each other.

Privacy legislation may mandate the confidentiality mechanisms that must be used in a jurisdiction. Unfortunately, at this point in time, these legislative efforts are not coordinated and jurisdictions are each developing their own legislation. Thus, privacy regulations vary across the state and federal government in the United States, as well as in Europe.

Confidentiality mechanisms are used for data in transit and in storage. Sensitive information passes through the following stages:
User browser to the seller web server: The SSL protocol encrypts data in transit between the user browser and the External Source's web server with symmetric key encryption. The system minimizes any sensitive information sent to or stored in their components on the seller's web server.
User browser to web server: The web server is externally accessible. All sensitive information that must be cached on the web server is protected.
Web server to application server or database, payment server to application server or database: The web server and payment server is externally accessible, the application server and database are internal systems. The system works with its service provider to ensure that data passing from externally exposed systems to internal systems is not be externally visible.
Application processing: The application server resides in the internal environment. Sensitive information that the application server places in persistent storage or cache are protected.
Application to database: This communication occurs over internal LAN. This environment is adequately secured, communications are either cleartext or encrypted.
Database storage: Sensitive information that are stored for a long time are protected against exposure. This reduces the chance that an employee can inadvertently or deliberately access the information. It also makes an intruder's ability to access information harder.
Application to ODFI: This will be a private interface. The ODFI has its own interface guidelines; and the system has ensured that their information's security is protected.

The privacy service's use of encryption addresses the issues of Key Management and Certificate Authority.

System Failure Handling and Recovery from failures are second-tier security concerns. Failures may or may not be caused by security problems; however, if they are not handled within specific time periods, the effect can be the same as a successful denial of service attack. The system incorporates the following:
System failure detection and reporting starts with logging and monitoring. Integrated system and application monitoring includes the DMZ systems and supporting services. The strategy addresses how outages are detected and to whom they are reported.
Disaster recovery planning covers procedures for a wide ranges of potential outages, from simple system failures to more catastrophic, widespread failures. The system has recovery plans for its applications so that recovery responsibilities are clear and can be tested consistently.
Internet attack recovery is a special case that will be addressed in the disaster recovery plans. The recovery assigns responsibilities to the service providers and to the system.

1-18. (canceled)

19. A system for user identity management comprising:
a security architecture capable of utilizing at least one authentication product embodied in a computer readable medium whereby the authentication product comprises at least one software application embodied in a computer readable medium and database architecture embodied in a computer readable medium combined with at least one external device;
wherein the external device is capable of rendering a unique identifier and a means for determining the presence of the physical device.

20. The system of claim 19, wherein the security architecture further comprises:
a plurality of external sources to be managed and maintained by the software application, wherein the security architecture is capable of segregating a plurality of information records such that the external sources have access to only information records under the control or permission of the external source; and
a means of providing administrative privileges to allow access to the information records.

21. The system of claim 19, wherein the software application and security architecture are capable of keeping track of each authentication device and ownership of each authentication device assignments to a plurality of the external sources and end users of the external sources over a plurality of the authentication devices.

22. The system of claim 20 wherein the authentication product is capable of identifying end users seeking authorization wherein each end user has an identifier information held in one of the information record such that at least one of the external sources can access the information record.

23. The system of claim 22 wherein the information record contains end user's name, personal information and passwords.

24. The system of claim 19 wherein the authentication product is capable of providing software piracy management and software anti-piracy capability to software manufacturers distributing application products via methods comprising optical media and the Internet.

25. The system of claim 19 wherein the authentication product is capable of providing software piracy management and software anti-piracy capability to software manufacturers distributing application products via methods comprising optical media and the internet wherein the method of utilization comprises but is not limited to the use of combination of individual product unique distribution identifier, individual end user identifier, and the external device.

26. An application using the authentication product of claim 19, wherein the application is capable of being deployed completely on a client's site, wherein the client comprises a client server, in which the client server is capable of functioning as a server application independent of the system.

27. The system of claim 19 wherein the external device is a serialized optical media.

28. The system of claim 27 wherein the optical media is produced as uniquely serialized without the requirement for an external code to be applied to packaging and additionally maintained by requiring additional algorithmic hashes and additional codes.

29. The system of claim 27 wherein the optical media may be identified by both unique identification and anti-copy mechanisms.

30. An autonomous standalone application comprising:
application software capable of allowing a software manufacturer to integrate a system for user identity management, wherein the system comprises:
a security architecture capable of utilizing at least one authentication product embodied in a computer readable medium whereby the authentication product comprises at least one software application embodied in a computer readable medium and database architecture embodied in a computer readable medium combined with at least one external device; and
wherein the external device is capable of rendering a unique identifier and a means for determining the presence of the physical device;
wherein the standalone application is autonomous to the authentication product;
wherein the standalone application is capable of maintaining information on each end user; and
wherein the external device is a serialized optical media.
